(19) United States
(12) Patent Application Publication
(10) Pub. No.: US 2026/0350768 A1
(43) Pub. Date: Nov. 5, 2026

(54) ILLUMINATION BALANCING FOR LENS SHADING CORRECTION IN DIGITAL IMAGE PROCESSING

(71) Applicant: Intel Products IP LLC, Santa Clara, CA (US)

(72) Inventors: Dmitry Grilikhes, Rehovot (IL); Andrey Semenjatshenco, Givataim (IL); Dor Barber, Herzliya (IL)

(73) Assignee: Intel Products IP LLC, Santa Clara, CA (US)

(21) Appl. No.: 19/722,758

(22) Filed: Jun. 27, 2026

(51) Int. Cl. G06T 5/94; G06T 5/80; H04N 25/61

(52) U.S. Cl. CPC G06T 5/94; G06T 5/80; G06T 2207/10024; H04N 25/61

(57) ABSTRACT

An image processing unit performs scene-adaptive illumination balancing by computing a correction table for a pixel correction circuit based on low-resolution image statistics and a base correction table. Statistics generation logic generates the image statistics, optionally as a luminance grid having a lower spatial resolution than image data. In some examples, illumination balancing logic identifies darker and brighter illumination regions, selects an illumination boundary threshold using an aggregate gradient metric over thresholded adjacent cells, and generates a spatial correction map using a three-part function providing smooth transitions. The spatial correction map may be modified based on one or more of a detected object region, an adaptive correction strength, or a maximum enhancement limit. The spatial correction map is resized and combined with the base correction table. A lens shading correction circuit may apply the resulting correction table to provide illumination balancing with little to no additional hardware overhead.

### BACKGROUND

Cameras are optical systems that capture and record light to create images. A camera can include components such as lenses, sensors, and processing units that process the signals captured by the sensors. Captured images can encounter image quality issues or artifacts, such as poor illumination imbalance.

### BRIEF DESCRIPTION OF THE DRAWINGS

Examples will be readily understood by the following detailed description in conjunction with the accompanying drawings. To facilitate this description, like reference numerals designate like structural elements. Examples are illustrated by way of example, and not by way of limitation, in the figures of the accompanying drawings.

FIG. 1 illustrates an imaging system having illumination balancing, according to some examples of the disclosure.

FIG. 2 is a flowchart illustrating a method for generating a mask, according to some examples of the disclosure.

FIG. 3 is a flowchart illustrating a method for finding an illumination boundary, according to some examples of the disclosure.

FIG. 4 is a flowchart illustrating a method for generating a smooth correction mask based on the illumination boundary, according to some examples of the disclosure.

FIG. 5 is a flowchart illustrating a method for handling one or more detected salient objects, according to some examples of the disclosure.

FIG. 6 is a flowchart illustrating a method for determining an adaptive correction strength, according to some examples of the disclosure.

FIG. 7 is a flowchart illustrating a method for implementing illumination balancing, according to some examples of the disclosure.

FIG. 8 is a flowchart illustrating a further method for implementing illumination balancing, according to some examples of the disclosure.

FIG. 9 is a block diagram of an example computing device, according to some examples of the disclosure.

### DETAILED DESCRIPTION

### Overview

An imaging system can include a sensor, and an image processing unit that processes the signals captured by the sensor. The sensor may capture a raw image, and the image processing unit may receive the raw image and produce a processed image. In many imaging environments, the raw image can include spatially non-uniform illumination, such as a darker illumination region and a brighter illumination region caused by backlighting, shadows, windows, or mixed lighting. Conventional global tone-mapping can improve overall brightness but may be limited in its ability to correct a darker region without undesirably affecting a brighter region. More spatially adaptive techniques may require additional processing resources, memory bandwidth, power, or dedicated hardware.

The image processing unit can address these issues by performing scene-adaptive illumination balancing using a pixel correction circuit that applies a correction table to image data. In some examples, the pixel correction circuit is a lens shading correction (LSC) circuit, and the correction table is generated from a base correction table, such as a base lens shading correction table. By modifying the correction table rather than adding a dedicated full-resolution correction block, the image processing unit can apply spatially varying illumination correction through existing correction table hardware.

In some examples, the image processing unit can include statistics generation logic that generates image statistics from image data captured by the sensor. The image data can have a spatial resolution, and the image statistics can have a further spatial resolution lower than the spatial resolution of the image data. In some examples, the image statistics include a luminance grid, or a luminance grid is derived from other sensor statistics. Processing the lower-resolution image statistics allows broad illumination patterns to be analyzed with reduced computation, memory, and bandwidth relative to full-resolution image processing.

In some examples, illumination balancing logic can compute the correction table based on the image statistics and the base correction table. The illumination balancing logic can generate a spatial correction map from the image statistics and combine the spatial correction map with the base correction table. For example, the spatial correction map may represent scene-dependent correction multipliers, while the base correction table may represent calibrated correction values associated with the pixel correction circuit. The resulting correction table can preserve the baseline correction behavior of the pixel correction circuit while adding scene-adaptive illumination balancing.

In some examples, to generate the spatial correction map, the illumination balancing logic can identify an illumination region and a further illumination region from the image statistics. The illumination region can be darker than the further illumination region. In some examples, the illumination balancing logic evaluates a plurality of candidate luminance thresholds, selects one of the candidate luminance thresholds as an illumination boundary threshold, and classifies cells of a luminance grid as part of the illumination region or the further illumination region using the illumination boundary threshold.

In some examples, the illumination boundary threshold can be selected using a spatial metric that evaluates how candidate thresholds divide the luminance grid. For a candidate luminance threshold, thresholded values can be assigned to cells of the luminance grid based on whether luminance values of the cells satisfy the candidate luminance threshold. An aggregate gradient metric can then be computed based on absolute differences between the thresholded values of adjacent cells of the luminance grid. The illumination boundary threshold can be selected based on the aggregate gradient metric, allowing the system to identify a spatially coherent boundary between illumination regions using a lightweight computation.

In some examples, the illumination balancing logic can determine whether correction should be activated. For example, if the image statistics satisfy a no-activation criterion, the illumination balancing logic can output the base correction table as the correction table. The no-activation criterion may correspond to a uniformly lit scene, an insufficient brightness difference between illumination regions, an insufficient area of the darker illumination region, or another condition indicating that illumination balancing is unnecessary or may produce undesirable artifacts.

In some examples, when correction is activated, the illumination balancing logic can generate the spatial correction map using a smooth function applied to luminance values. In some examples, the spatial correction map is generated by applying a three-part function that includes a curved portion below a lower transition point, a linear transition portion between the lower transition point and an upper transition point, and a further curved portion above the upper transition point. The lower transition point and the upper transition point can be defined based on the illumination boundary threshold. This allows stronger correction to be applied to darker regions while providing smooth transitions near the illumination boundary.

In some examples, the correction may be further adapted based on scene characteristics. The illumination balancing logic can determine a correction strength based on one or more of a brightness ratio between the illumination region and the further illumination region and a relative area weight between the illumination region and the further illumination region. The correction strength can scale the spatial correction map or affect computation of the correction table. In some examples, the illumination balancing logic can limit a correction multiplier or a correction value based on a maximum enhancement limit, which can reduce noise amplification, saturation, and artificial-looking image changes.

In some examples, the illumination balancing logic can modify the spatial correction map based on a detected object region. For example, if a detected object region intersects a correction region of the spatial correction map, the illumination balancing logic can extend or reshape the correction region. This can improve visual consistency for a salient object, such as a face, by reducing abrupt or inconsistent correction across different portions of the object.

In some examples, after the spatial correction map is generated, the illumination balancing logic can resize the spatial correction map to a size of the base correction table and perform elementwise multiplication of values of the resized spatial correction map with values of the base correction table. The resulting correction table can then be applied by the pixel correction circuit. In some examples, the pixel correction circuit is upstream of bit depth reduction logic or downsampling logic, allowing illumination balancing to be applied early in the image processing pipeline at relatively high bit depth or resolution.

The technique can also be implemented in a frame-to-frame processing pipeline. Image statistics may be derived from a frame, and the illumination balancing logic may compute the correction table for a further frame subsequent to the frame. This allows statistics collected during processing of one frame to guide correction applied to a later frame, which can be useful in video, preview, or continuous capture modes.

These techniques can be implemented in image processing units, image signal processors, camera systems, mobile devices, embedded imaging systems, or software and firmware stored on non-transitory computer-readable media. By using lower-resolution image statistics to compute a scene-adaptive correction table for a pixel correction circuit, the system can provide illumination balancing with low computational cost, little to no additional hardware overhead, smooth correction transitions, adaptive correction strength, and improved handling of scenes having distinct illumination regions.

Image Processing Unit with Illumination Balancing

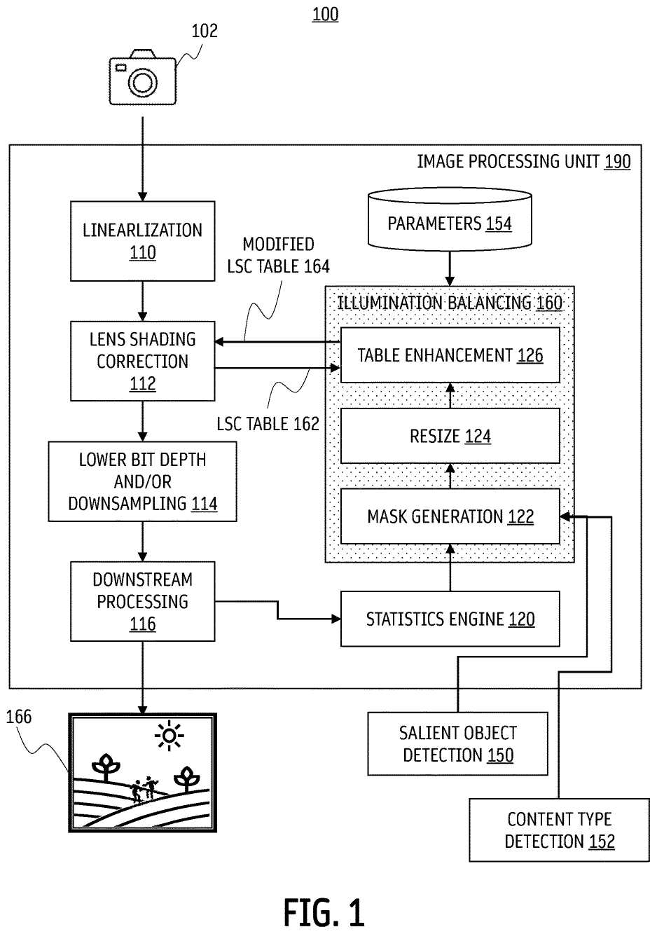

FIG. 1 illustrates imaging system 100 having illumination balancing, according to some examples of the disclosure. Imaging system 100 can include sensor 102 and image processing unit 190. Sensor 102 can capture image data, such as raw image data, and image processing unit 190 can process the image data to generate processed image 166. Image processing unit 190 can include one or more of linearization 110, lens shading correction 112, lower bit depth and/or downsampling 114, downstream processing 116, statistics engine 120, illumination balancing 160, salient object detection 150, content type detection 152, and parameters 154.

In some examples, sensor 102 can output image data having a spatial resolution. Linearization 110 can receive the image data and perform one or more linearization operations. Lens shading correction 112 can receive the linearized image data and apply a correction table to the image data. In some examples, lens shading correction 112 can be one of the first correction blocks applied to image data in image processing unit 190, such that illumination balancing can be performed as an early-stage correction rather than as a later post-processing operation. This placement can allow image processing unit 190 to adjust image data before downstream blocks make decisions or perform processing based on the image data.

In some examples, lens shading correction 112 can operate as a pixel correction circuit. In some examples, lens shading correction 112 applies LSC table 162 to compensate for optical lens shading. Illumination balancing 160 can generate modified LSC table 164 based on LSC table 162 and image statistics generated by statistics engine 120. Lens shading correction 112 can then apply modified LSC table 164 to image data. In this manner, image processing unit 190 can perform scene-adaptive illumination balancing by changing a correction table used by an existing pixel correction circuit, rather than adding a separate full-resolution tone-mapping block or changing the downstream image processing chain.

This table-based implementation can cause image processing unit 190 to process image data as if the image data had been captured under more balanced illumination conditions. For example, modified LSC table 164 can increase correction applied to a darker illumination region while reducing or avoiding additional correction in a brighter illumination region. Subsequent blocks of image processing unit 190, including lower bit depth and/or downsampling 114 and downstream processing 116, can then operate on image data that has already been illumination-balanced. Accordingly, downstream processing 116 can proceed using existing processing operations, while lens shading correction 112 and modified LSC table 164 provide correction earlier in the pipeline.

In some examples, lens shading correction 112 is positioned upstream of lower bit depth and/or downsampling 114. Applying modified LSC table 164 at this stage can preserve dynamic range and spatial information that may be reduced or lost after lower bit depth and/or downsampling 114. This can be technically advantageous relative to correction performed later in the pipeline, because illumination balancing can be applied while image data remains closer to the raw sensor data and before later tone-mapping, downsampling, or bit depth reduction affects the available image information.

In some examples, statistics engine 120 can operate as statistics generation logic that generates image statistics having a spatial resolution lower than the spatial resolution of the image data. In some examples, statistics engine 120 generates or provides a luminance grid. In other examples, statistics engine 120 provides red-green-blue-saturation (RGBS) statistics or sensor statistics, and luminance values are derived from those statistics. Using lower-resolution image statistics allows illumination balancing 160 to analyze large-scale illumination distribution without processing the full-resolution image for scene analysis. This can reduce computation, memory bandwidth, and power while still providing a sufficiently large receptive field for detecting broad illumination regions.

In some examples, illumination balancing 160 can compute modified LSC table 164 based on the image statistics and LSC table 162. Illumination balancing 160 can include mask generation 122, resize 124, and table enhancement 126. Mask generation 122 can generate a spatial correction map from the image statistics. Resize 124 can resize the spatial correction map to a size of LSC table 162. Table enhancement 126 can combine the resized spatial correction map with LSC table 162, for example by elementwise multiplication, to generate modified LSC table 164. Thus, LSC table 162 can provide baseline correction associated with lens shading correction 112, while the spatial correction map can provide scene-adaptive illumination balancing.

In some examples, mask generation 122 can analyze image statistics to identify an illumination region and a further illumination region. The illumination region can be darker than the further illumination region. In some examples, mask generation 122 evaluates candidate luminance thresholds, selects an illumination boundary threshold, and classifies cells of a luminance grid as part of the illumination region or the further illumination region using the illumination boundary threshold. The illumination boundary threshold may be selected using an aggregate gradient metric based on absolute differences between thresholded values of adjacent cells of the luminance grid. Such a gradient-based metric can provide a computationally simple way to identify a spatially coherent illumination boundary using a relatively small statistics grid.

In some examples, illumination balancing 160 can use parameters 154 to control one or more of activation, transition behavior, correction strength, and correction limits. For example, parameters 154 can include one or more of: one or more thresholds for determining whether a scene has sufficient illumination imbalance to activate correction, one or more area thresholds for determining whether a darker illumination region occupies a meaningful portion of the image, one or more smoothness parameters for controlling transitions near an illumination boundary, and one or more maximum enhancement limits.

In some examples, if image statistics satisfy a no-activation criterion, illumination balancing 160 can output LSC table 162 as modified LSC table 164 or cause lens shading correction 112 to use LSC table 162 without additional illumination balancing. This can avoid unnecessary correction in uniformly illuminated scenes or scenes in which the darker region is too small to warrant correction.

In some examples, when correction is activated, mask generation 122 can generate the spatial correction map to improve the darker illumination region while preserving the brighter further illumination region. In some examples, mask generation 122 applies a three-part function to luminance values, including a curved portion below a lower transition point, a linear transition portion between the lower transition point and an upper transition point, and a further curved portion above the upper transition point. The lower transition point and upper transition point can be defined based on the illumination boundary threshold. This can provide a smooth transition between corrected and preserved regions, reducing visible jumps, halos, or artifacts near an illumination boundary.

In some examples, illumination balancing 160 can adapt modified LSC table 164 based on a correction strength. The correction strength can depend on one or more of a brightness ratio between the illumination region and the further illumination region and a relative area weight between the illumination region and the further illumination region. For example, correction can be weaker when illumination imbalance is mild or when the darker illumination region occupies a relatively small area, and stronger when the darker illumination region is significant and substantially darker than the brighter further illumination region.

In some examples, illumination balancing 160 can augment modified LSC table 164 and/or the spatial correction map based on a maximum enhancement limit to limit correction multipliers to reduce noise amplification, saturation, and artificial-looking changes.

In some examples, salient object detection 150 and/or content type detection 152 can provide additional information to illumination balancing 160. In some examples, salient object detection 150 can detect a detected object region, such as a face region or another salient object region. If the detected object region intersects a correction region of the spatial correction map, mask generation 122 can modify the spatial correction map by extending or reshaping the correction region. This can reduce inconsistent correction across different portions of the same object, such as a face that is partially within a darker illumination region. In some examples, content type detection 152 can provide scene type or content information that may be used to select or adjust parameters 154, activation behavior, correction strength, or transition behavior.

Illumination balancing 160 can be implemented in firmware, hardware, software, or a combination thereof. In some examples, lens shading correction 112 is implemented as fixed-function hardware that already applies LSC tables, while illumination balancing 160 can be implemented in firmware and/or software that computes modified LSC table 164. In other examples, one or more portions of illumination balancing 160, such as mask generation 122, resize 124, or table enhancement 126, may be implemented using programmable hardware, dedicated hardware logic, a processor executing instructions, or mixed hardware and firmware. This flexibility allows scene-adaptive illumination balancing to be added with little to no extra hardware overhead, because existing lens shading correction infrastructure can be reused.

In some examples, illumination balancing 160 produces modified LSC table 164 for a further frame subsequent to a frame from which image statistics are generated. For example, statistics engine 120 can generate image statistics from a current frame, and illumination balancing 160 can compute modified LSC table 164 for application by lens shading correction 112 to a next frame or another later frame. Illumination balancing 160 need not compute modified LSC table 164 for every frame. Instead, illumination balancing 160 can compute modified LSC table 164 periodically, after a predetermined number of frames, in response to detecting a change in scene content, in response to detecting a change in illumination distribution, in response to detecting motion or a change in exposure, in response to a trigger from salient object detection 150 and/or content type detection 152, or based on any other suitable trigger. This can reduce processing load, power consumption, and table update bandwidth while still allowing imaging system 100 to adapt modified LSC table 164 when illumination conditions change.

In some examples, illumination balancing 160 can compute modified LSC table 164 in a manner that is compatible with an existing table format used by lens shading correction 112. For example, LSC table 162 and modified LSC table 164 may include a grid of correction coefficients, gain values, multiplier values, per-color-channel values, or per-cell table entries. Table enhancement 126 can preserve a table dimension, coefficient ordering, interpolation format, bit depth, quantization format, memory layout, and update protocol expected by lens shading correction 112. Preserving the table format can allow modified LSC table 164 to be applied by existing lens shading correction hardware without changing a pixel-processing datapath of lens shading correction 112.

In some examples, modified LSC table 164 can include one or more channel-specific correction tables. For example, table enhancement 126 can generate correction values for red, green, blue, clear, luminance, or color-filter-array channels. In some examples, the same spatial correction map is applied to multiple color channels to provide luminance-like illumination balancing. In some examples, different channel weights are used to reduce color shift, maintain white balance, compensate for channel-dependent lens shading, or account for white balance gains used by image processing unit 190. Channel-aware table generation can allow illumination balancing 160 to brighten a darker illumination region while reducing color artifacts that might arise from applying unequal gains across color channels.

In some examples, illumination balancing 160 can temporally filter, smooth, or stabilize modified LSC table 164 before the table is applied by lens shading correction 112. For example, illumination balancing 160 can blend a newly computed correction table with a previously used correction table, limit a frame-to-frame change in a correction coefficient, apply hysteresis to activation or deactivation of illumination balancing, require a scene change to persist for multiple frames before updating modified LSC table 164, or gradually ramp correction strength over multiple frames. Temporal stabilization can reduce visible flicker, pumping, or abrupt brightness changes in video, preview, burst capture, and continuous capture modes.

In some examples, illumination balancing 160 can use confidence or reliability information when generating the spatial correction map or modified LSC table 164. For example, mask generation 122 can reduce a contribution of saturated cells, clipped cells, invalid statistics, low-confidence statistics, defective sensor locations, statistics affected by motion, or statistics affected by very low signal level. In some examples, such cells are excluded from illumination boundary detection, illumination distribution analysis, adaptive correction strength computation, or table enhancement. Using reliability information can improve robustness by reducing the likelihood that noise, saturation, sensor defects, or transient artifacts cause an inaccurate illumination boundary or an excessive correction strength.

In some examples, illumination balancing 160 can support more than two illumination regions while still using the darker illumination region and brighter further illumination region framework described above. For example, mask generation 122 can identify a plurality of illumination regions, generate multiple candidate correction regions, generate a spatial correction map having more than two correction levels, or apply multiple illumination boundary thresholds. In some examples, a multi-region analysis is reduced to a darker illumination region and a brighter further illumination region for correction table generation. In some examples, different portions of a spatial correction map correspond to different correction strengths. This can allow illumination balancing 160 to handle scenes having complex lighting while preserving the efficient table-based correction approach.

In some examples, parameters 154 can be stored in registers, firmware configuration data, non-volatile memory, tuning tables, calibration data, or mode-specific configuration data accessible to illumination balancing 160. Parameters 154 can include an enable parameter, a brightness ratio threshold, a minimum area percentage, an area transition smoothness value, a base correction strength, a maximum enhancement limit, a transition smoothness value, a shadow correction level, a highlight preservation level, scene type parameters, object-refinement parameters, and temporal stability parameters. Storing such parameters separately from the pixel-processing datapath can allow illumination balancing behavior to be tuned for a product, sensor, lens, capture mode, or image quality target without redesigning lens shading correction 112.

In some examples, illumination balancing 160 can be implemented using fixed-point arithmetic, integer arithmetic, lookup tables, piecewise linear approximations, reduced-precision arithmetic, vector operations, scalar processor instructions, digital signal processor instructions, graphics processor instructions, programmable hardware, or dedicated hardware logic. For example, one or more functions used for threshold evaluation, smooth mask generation, adaptive strength computation, resizing, or table enhancement can be implemented using lookup tables or piecewise approximations to reduce multiplication, division, square-root, or floating-point operations. Such implementations can reduce latency, area, and power while maintaining correction quality sufficient for real-time image processing.

In some examples, modified LSC table 164 can precondition image data for one or more downstream operations of image processing unit 190. Because lens shading correction 112 is upstream of lower bit depth and/or downsampling 114 and downstream processing 116, modified LSC table 164 can change image data before downstream exposure, tone-mapping, local tone-mapping, color processing, contrast enhancement, or detail enhancement operates on the image data. This can allow downstream processing 116 to operate on image data that more closely resembles data captured under more balanced illumination conditions, while illumination balancing 160 itself continues to be implemented through a correction table applied by a pixel correction circuit.

In some examples, resizing performed by resize 124 can account for differences among a coordinate system of the luminance grid, a coordinate system of the correction mask, a coordinate system of LSC table 162, and a coordinate system of image data processed by lens shading correction 112. For example, resize 124 can perform nearest-neighbor resizing, bilinear resizing, bicubic resizing, area-based resizing, grid remapping, cropping adjustment, aspect-ratio adjustment, sensor-window adjustment, binning adjustment, or scaling adjustment. Coordinate-aware resizing can help align a correction region identified from lower-resolution statistics with corresponding locations in LSC table 162 and image data, thereby improving spatial accuracy of illumination balancing.

In some examples, illumination balancing 160 can select among multiple base correction tables before generating modified LSC table 164. For example, LSC table 162 can be selected based on lens position, zoom state, focus position, sensor mode, color temperature, illuminant type, capture mode, exposure setting, or calibration data. Illumination balancing 160 can then combine the selected base correction table with a spatial correction map. Selecting an appropriate base correction table before scene-adaptive modification can preserve optical lens shading compensation under different capture conditions while still allowing the spatial correction map to provide localized illumination balancing.

In some examples, illumination balancing 160 can output diagnostic data, confidence data, or metadata associated with modified LSC table 164. For example, illumination balancing 160 can output an activation state, selected illumination boundary threshold, aggregate gradient metric, brightness ratio, area weight, correction strength, maximum correction multiplier, scene type, detected object intersection state, or table update state. Such metadata can be used by downstream processing 116, firmware tuning tools, image quality analysis tools, debug logic, or control logic that determines whether to update modified LSC table 164 for a subsequent frame.

### Generating a Spatial Correction Map

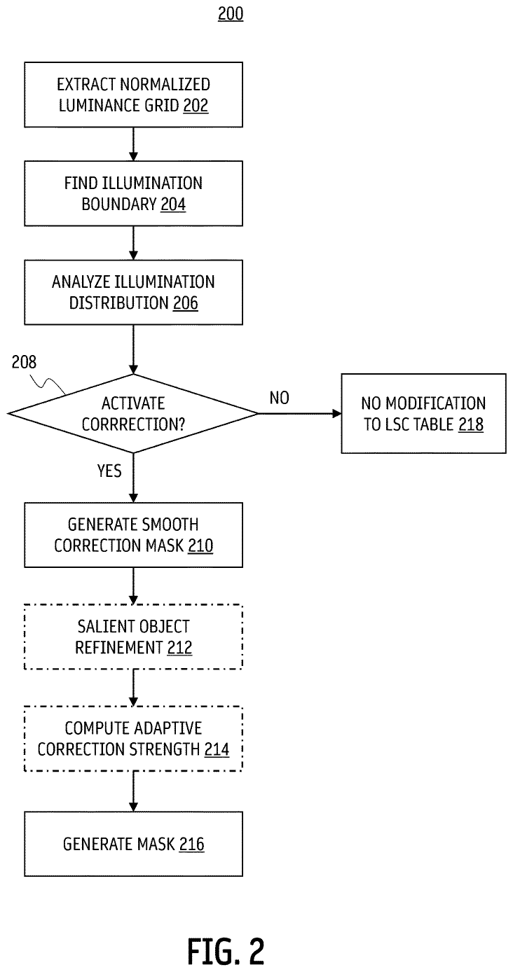

FIG. 2 is a flowchart illustrating method 200 for generating a mask, according to some examples of the disclosure. Method 200 can be performed by mask generation 122 of illumination balancing 160, as illustrated in FIG. 1. More generally, method 200 can be performed by illumination balancing logic, firmware executed by image processing unit 190, hardware logic, or a combination of hardware and firmware. Method 200 can generate a spatial correction map, a correction mask, a multiplier map, or another representation of scene-adaptive illumination balancing to be combined with a base correction table, such as LSC table 162.

As used herein, a mask can refer to a spatially varying representation of correction values, weights, gains, multipliers, attenuation values, blending values, or values that indicate how illumination balancing is to be applied across image data or across a correction table. The generated mask can identify how strongly different spatial regions or luminance regions should be corrected before resize 124 and table enhancement 126 generate modified LSC table 164, as illustrated in FIG. 1.

In 202, mask generation 122 extracts a normalized luminance grid. As used herein, a luminance grid can refer to an array, map, matrix, or a spatial arrangement of luminance values derived from image data or image statistics. Performing the extraction can include obtaining image statistics from statistics engine 120, as illustrated in FIG. 1, and generating luminance values having a further spatial resolution lower than a spatial resolution of image data processed by lens shading correction 112. In some examples, statistics engine 120 directly provides the luminance grid. In other examples, mask generation 122 derives the luminance grid from RGBS statistics or sensor statistics by extracting or computing luminance from color-channel and/or saturation information. At a generalized level, 202 provides lower-resolution image statistics that represent broad illumination distribution in a frame. At an implementation level, 202 may be represented as:

luminance_grid = EXTRACT_LUMINANCE(frame_information)

Using a normalized luminance grid can allow illumination balancing 160 to operate on a compact statistics grid rather than on a full-resolution image, reducing computation, memory bandwidth, and power.

In 204, mask generation 122 finds an illumination boundary. As used herein, an illumination boundary can refer to a boundary, threshold, transition, or classification criterion separating an illumination region from a further illumination region based on luminance values or image statistics. In some examples, performing illumination boundary detection can include evaluating a plurality of candidate luminance thresholds and selecting one candidate luminance threshold as an illumination boundary threshold. In some examples, cells of the luminance grid are classified, for each candidate luminance threshold, as belonging to an illumination region or a further illumination region. The illumination region can be darker than the further illumination region. In some examples, 204 separates lower-resolution image statistics into regions corresponding to different illumination conditions. In some examples, 204 can include assigning thresholded values to cells of the luminance grid based on whether luminance values of the cells satisfy a candidate luminance threshold, computing an aggregate gradient metric based on absolute differences between thresholded values of adjacent cells, and selecting the illumination boundary threshold based on the aggregate gradient metric. In pseudocode, 204 may include:

optimal_threshold =
FIND_ILLUMINATION_BOUNDARY(luminance_grid)

This provides a lightweight spatial mechanism for identifying a boundary between illumination regions without requiring full-resolution tone-mapping.

In some examples, finding an illumination boundary in 204 can be performed using a neural network trained to infer an illumination boundary threshold, an illumination region classification, or a spatial boundary map from the luminance grid. The neural network can receive lower-resolution image statistics as input and output data usable by mask generation 122 to distinguish an illumination region from a further illumination region.

In 206, mask generation 122 analyzes an illumination distribution. As used herein, an illumination distribution can refer to a spatial, statistical, or spatial-statistical characterization of how luminance, brightness, exposure, or illumination-related values are distributed across image data or image statistics. Performing the analysis can include determining scene characteristics using the luminance grid and the illumination boundary identified in 204. In some examples, mask generation 122 determines an average brightness of a darker illumination region, an average brightness of a brighter further illumination region, a brightness ratio between the regions, an area of the darker illumination region, an area of the brighter further illumination region, or a relative area weight between the regions. In some examples, 206 determines whether the frame has a meaningful illumination imbalance that merits correction. At an implementation level, 206 may be represented as:

scene_characteristics =
ANALYZE_ILLUMINATION_DISTRIBUTION(luminance_grid,
optimal_threshold)

This analysis can avoid treating every frame as a two-region illumination problem and can reduce visible artifacts that might occur if illumination balancing were applied to uniformly lit scenes or scenes having only a small dark region.

In 208, mask generation 122 determines whether to activate correction. Performing the determination can include evaluating whether image statistics or information from performing 206 satisfy a no-activation criterion. As used herein, a no-activation criterion can refer to one or more conditions indicating that illumination balancing is to be bypassed, reduced, or disabled such that a base correction table is output as the correction table. In some examples, the no-activation criterion is satisfied based on one or more of a brightness ratio between an illumination region and a further illumination region failing to satisfy a threshold, an area of the illumination region failing to satisfy a minimum area threshold, a relative area weight failing to satisfy a threshold, a candidate luminance threshold failing to produce a material split between the illumination region and the further illumination region, a ratio of cells classified as the illumination region being below a lower split threshold, a ratio of cells classified as the illumination region being above an upper split threshold, a scene being substantially uniformly illuminated, a brightness ratio weight having a zero value, an area weight having a zero value, a correction strength having a zero value, a correction strength failing to satisfy a minimum strength threshold, or an illumination balancing enable parameter indicating that illumination balancing is disabled. In some examples, 208 acts as a gating operation that determines whether scene-adaptive illumination balancing should modify the base correction table. At an implementation level, 208 may be represented as:

IF NOT SHOULD_ACTIVATE_CORRECTION(scene_characteristics) THEN
RETURN original_lens_shading_tables

If correction is not activated, method 200 proceeds to 218. If correction is activated, method 200 proceeds to 210.

In 218, illumination balancing 160 performs no modification to LSC table 162. Performing no modification can include outputting LSC table 162 as modified LSC table 164, causing lens shading correction 112 to continue using LSC table 162, or refraining from applying a scene-adaptive mask to the base correction table. In some examples, 218 is performed when image statistics satisfy the no-activation criterion evaluated in 208. This can preserve baseline optical lens shading compensation while avoiding unnecessary shadow enhancement, noise amplification, saturation, or artificial-looking changes in scenes for which illumination balancing is not expected to improve image quality.

In 210, mask generation 122 generates a smooth correction mask. As used herein, a smooth correction mask can refer to a mask having correction values that vary gradually between different correction levels, different illumination regions, or different spatial regions. Performing smooth correction mask generation can include generating a spatial correction map using the illumination region and the further illumination region identified using the illumination boundary. In some examples, mask generation 122 applies a three-part function to luminance values, the three-part function including a curved portion below a lower transition point, a linear transition portion between the lower transition point and an upper transition point, and a further curved portion above the upper transition point. The lower transition point and upper transition point can be defined based on the illumination boundary threshold. In some examples, 210 generates stronger correction for darker regions and weaker correction or preservation for brighter regions. At an implementation level, 210 may be represented as:

correction_mask = GENERATE_SIGMOID_MASK(luminance_grid,
optimal_threshold)

The smooth transition can reduce hard edges, halos, and visible discontinuities near the illumination boundary.

In 212, mask generation 122 optionally performs salient object refinement. As used herein, salient object refinement can refer to modifying a mask, spatial correction map, correction region, or correction value based on a detected object region. Performing salient object refinement can include receiving detected object information from salient object detection 150, as illustrated in FIG. 1, and modifying the correction mask based on the detected object region. As used herein, a correction region can refer to a portion of a mask, spatial correction map, luminance grid, correction table, or image region for which illumination balancing correction is applied, increased, decreased, blended, or controlled. In some examples, if a detected object region intersects a correction region of the correction mask, mask generation 122 extends or reshapes the correction region based on the detected object region. The detected object region may correspond to a face, body, foreground object, or salient region. In some examples, 212 allows semantic or object-location information to refine, modify, or augment a luminance-based correction mask. At an implementation level, 212 may be represented as:

IF face_detection_enabled AND face_detected THEN
correction_mask = APPLY_FACE_ENHANCEMENT(correction_mask,
face_coordinates)

This can reduce inconsistent correction across different portions of the same salient object, such as a face that is partially within a darker illumination region.

In 214, mask generation 122 or illumination balancing 160 optionally computes an adaptive correction strength. As used herein, adaptive correction strength can refer to a scalar, weight, gain, coefficient, function, or set of values that controls an amount of illumination balancing based on one or more scene characteristics. Performing the computation can include determining correction strength based on one or more of a brightness ratio between an illumination region and a further illumination region and a relative area weight between the illumination region and the further illumination region. In some examples, the brightness ratio controls how strongly darker regions should be enhanced, while the relative area weight controls whether the darker region is large enough to merit meaningful correction. In some examples, 214 scales correction according to severity of illumination imbalance. At an implementation level, 214 may be represented as:

correction_strength =
CALCULATE_ADAPTIVE_STRENGTH(brightness_ratio_weight,
area_weight)

The correction strength may also be subject to a maximum enhancement limit, which can reduce noise amplification, saturation, and unnatural enhancement.

In 216, mask generation 122 generates the mask. Performing mask generation can include applying the adaptive correction strength to the smooth correction mask and/or applying one or more maximum enhancement limits. Performing mask generation can include outputting a final mask for use by resize 124 and table enhancement 126, as illustrated in FIG. 1. In some examples, the final mask is a spatial correction map that is later resized to a size of LSC table 162 and combined with LSC table 162 to generate modified LSC table 164. In some examples, 216 outputs scene-adaptive illumination balancing information that can be combined with a base correction table associated with a pixel correction circuit. At an implementation level, subsequent processing may be represented as:

enhanced_lens_shading_tables = lens_shading_tables *
RESIZE(correction_mask * correction_strength,
lens_shading_tables.size)

Method 200 can produce a mask that allows existing lens shading correction infrastructure to apply illumination balancing with little to no additional hardware overhead.

### Selecting an Illumination Boundary Threshold

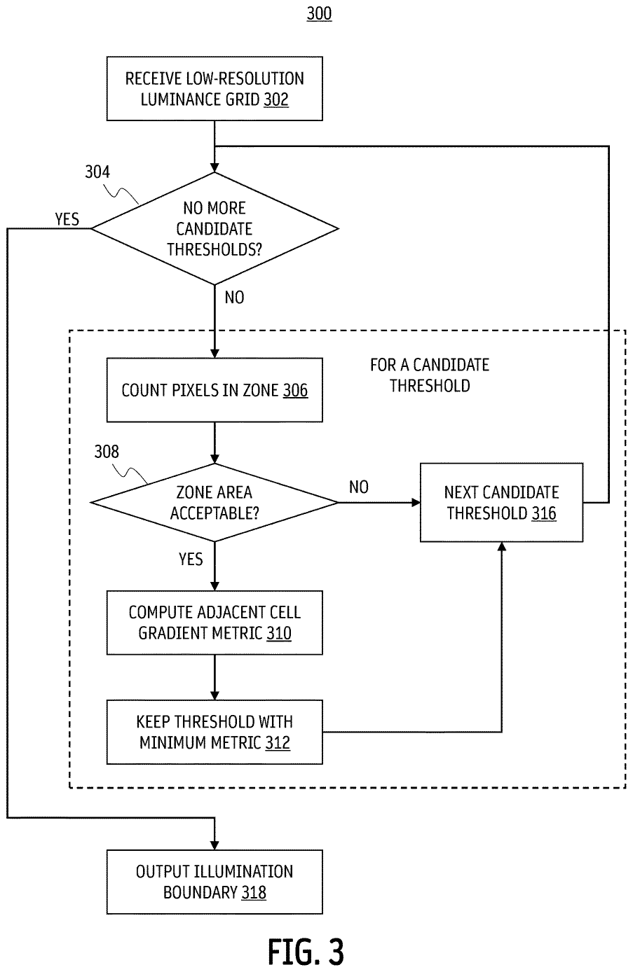

FIG. 3 is a flowchart illustrating method for finding an illumination boundary, according to some examples of the disclosure. Method 300 can correspond to finding illumination boundary in 204 of method 200, as illustrated in FIG. 2. Method 300 can be performed by mask generation 122 of illumination balancing 160, as illustrated in FIG. 1. In some examples, method 300 can be performed by illumination balancing logic that evaluates candidate luminance thresholds and selects one of the candidate luminance thresholds as an illumination boundary threshold. As used herein, an illumination boundary threshold can refer to a luminance threshold, brightness threshold, classification value, learned value, or computed value used to distinguish an illumination region from a further illumination region. In some examples, the illumination region is darker than the further illumination region.

In 302, mask generation 122 receives a low-resolution luminance grid. Performing the receiving can include receiving the luminance grid from operation 202, as illustrated in FIG. 2, or from statistics engine 120, as illustrated in FIG. 1. As used herein, a low-resolution luminance grid can refer to a spatial arrangement of luminance values having a further spatial resolution lower than a spatial resolution of image data processed by lens shading correction 112. In some examples, the low-resolution luminance grid is generated from sensor statistics, such as RGBS statistics, and represents broad illumination distribution using far fewer cells than the full-resolution image. Using the low-resolution luminance grid allows method 300 to search for a spatial illumination boundary using a compact input, which can reduce computation, memory access, and power relative to full-resolution analysis.

In 304, mask generation 122 determines whether there are no more candidate thresholds to evaluate. Performing the determination can include iterating through a plurality of candidate luminance thresholds over a candidate threshold range. In some examples, the candidate threshold range can be predefined, tunable, content-dependent, exposure-dependent, derived from luminance statistics, or selected using parameters 154, as illustrated in FIG. 1. At an implementation level, 304 can correspond to a loop condition such as:

FOR threshold_step = 0 TO 100 DO
current_threshold = threshold_step * 0.002

When candidate thresholds remain, method 300 proceeds to the dashed process region shown in FIG. 3 for a candidate threshold. When no candidate thresholds remain, method 300 proceeds to 318 to output the selected illumination boundary.

In 306, mask generation 122 counts pixels in a zone for a candidate threshold. Performing the counting can include classifying cells of the low-resolution luminance grid based on whether luminance values of the cells satisfy the candidate luminance threshold. For example, cells having luminance values below the candidate luminance threshold can be counted as part of a darker illumination region, while cells having luminance values above the candidate luminance threshold can be counted as part of a brighter further illumination region. As used herein, a zone can refer to a set of cells, pixels, grid locations, image regions, statistics regions, or table regions that are classified together for illumination analysis. At an implementation level, 306 can correspond to:

dark_pixel_count = COUNT_PIXELS_BELOW(luminance_grid,
current_threshold)
dark_ratio = dark_pixel_count / total_pixels

This operation provides region-size information that can be used to avoid selecting thresholds that create trivial, unstable, or visually insignificant illumination regions.

In 308, mask generation 122 determines whether a zone area is acceptable. Performing the determination can include comparing a ratio of cells classified into a zone with one or more area criteria. In some examples, the area criteria checks if the darker illumination region occupies at least a minimum area percentage and at most an upper split percentage. For example, candidate thresholds may be evaluated further only when the candidate threshold produces a darker region ratio that satisfies a lower bound and an upper bound. At an implementation level, 308 can correspond to:

IF dark_ratio >= minimum_area_percentage AND dark_ratio <=
upper_split_limit THEN

Candidate thresholds that fail the zone area test can be skipped by proceeding to 316. This can prevent method 300 from selecting a threshold that isolates a very small shadow, a few saturated cells, a specular highlight, sensor noise, or a split that does not represent a meaningful or material two-region illumination imbalance.

In 310, mask generation 122 computes an adjacent cell gradient metric for a candidate threshold that satisfies the zone area test. Performing the computation can include assigning thresholded values to cells of the luminance grid based on whether luminance values of the cells satisfy the candidate threshold, comparing thresholded values of adjacent cells, and accumulating absolute differences between the thresholded values of adjacent cells. As used herein, a thresholded value can refer to a binary, categorical, quantized, or classification value assigned to a cell after applying a candidate luminance threshold. As used herein, an adjacent cell can refer to a horizontally adjacent cell, vertically adjacent cell, diagonally adjacent cell when used, or a neighboring cell according to a selected neighborhood pattern. At an implementation level, 310 can correspond to:

```
gradient_sum = 0
FOR each adjacent cell pair IN luminance_grid DO
  current_value = 1 IF luminance[current_cell] <
current_threshold ELSE 0
  adjacent_value = 1 IF luminance[adjacent_cell] <
current_threshold ELSE 0
  gradient_sum = gradient_sum + ABS(current_value −
adjacent_value)
END FOR
```

The aggregate gradient metric can also distinguish between candidate thresholds that produce similar quantities of dark and bright cells but different spatial arrangements of those cells. For example, a first candidate threshold may classify cells into a compact darker illumination region adjacent to a compact brighter illumination region, while a second candidate threshold may classify a similar number of cells into scattered darker and brighter islands. Even if the first and second candidate thresholds produce similar zone areas, the first candidate threshold can have a lower aggregate gradient metric because fewer adjacent cell pairs cross between thresholded values. Selecting the threshold with the lower aggregate gradient metric can favor a correction mask having fewer fragmented correction regions and smoother transitions after mask generation.

In some examples, the aggregate gradient metric can be normalized based on a number of evaluated adjacent cell pairs, a size of the luminance grid, a number of valid cells in the luminance grid, or a number of cells satisfying one or more reliability criteria. Normalization can allow aggregate gradient metrics to be compared across luminance grids of different sizes, cropped regions, invalid-cell patterns, or downscaled statistics configurations. In some examples, cells may be excluded from the aggregate gradient metric when the cells correspond to saturated regions, invalid statistics, defective sensor locations, low-confidence statistics, or regions outside an analysis window.

In some examples, adjacent cell pairs used to compute the aggregate gradient metric can include horizontal neighbors, vertical neighbors, diagonal neighbors, or neighbors selected according to a configurable neighborhood pattern. Different neighborhood patterns can change sensitivity to horizontal, vertical, diagonal, or irregular illumination boundaries. In some examples, adjacent cell differences may be weighted based on position in the luminance grid, confidence of image statistics, proximity to a detected object region, proximity to an image border, or a content type indicated by content type detection 152, as illustrated in FIG. 1.

In some examples, the aggregate gradient metric can be combined with one or more additional selection criteria when selecting the illumination boundary threshold. For example, mask generation 122 can select a candidate luminance threshold based on the aggregate gradient metric and one or more of a zone area criterion, a brightness ratio criterion, a temporal stability criterion, a hysteresis criterion, a confidence criterion, or a correction strength criterion. Combining the aggregate gradient metric with such criteria can reduce threshold flicker between frames and can prevent selection of a threshold that is spatially smooth but produces insufficient illumination separation for useful correction.

The adjacent cell gradient metric of 310 can be advantageous relative to Otsu-style thresholding for illumination balancing. Otsu thresholding generally selects a threshold based on histogram statistics, such as between-class variance, and therefore does not directly evaluate how thresholded cells are spatially arranged in the luminance grid. In contrast, 310 evaluates absolute differences between thresholded values of adjacent cells. This allows method 300 to favor a candidate threshold that produces a spatially coherent separation between illumination regions. The gradient-based metric can also be computationally simple because it can use threshold comparisons, adjacent cell differences, absolute values, and accumulation, without requiring a full histogram variance calculation for each candidate threshold. This can be especially useful when the luminance grid is small and the goal is to identify a broad illumination boundary for correction table generation.

In 312, mask generation 122 keeps the threshold with the minimum metric.

Performing this operation can include comparing the adjacent cell gradient metric computed in 310 with a stored minimum metric and updating the stored illumination boundary threshold when the current candidate threshold has a lower metric. In some examples, the kept threshold is the candidate luminance threshold that produces the lowest aggregate gradient metric among candidate thresholds that satisfy the zone area criteria of 308. At an implementation level, 312 can correspond to:

```
IF gradient_sum < minimum_gradient_metric THEN
  minimum_gradient_metric = gradient_sum
  optimal_threshold = current_threshold
END IF
```

Keeping the threshold with the minimum metric can select a threshold that separates darker and brighter illumination regions with a relatively smooth or coherent boundary, which can support smoother downstream mask generation.

In 316, mask generation 122 advances to a next candidate threshold. Performing this operation can include incrementing a threshold index, selecting a next threshold value from a list of candidate thresholds, updating a threshold step, or selecting a next candidate threshold based on a search strategy. In some examples, 316 returns method 300 to 304 so that mask generation 122 can determine whether additional candidate thresholds remain. The dashed process region in FIG. 3 illustrates that 306, 308, 310, 312, and 316 can be repeated for multiple candidate thresholds. This iterative evaluation allows method 300 to compare multiple possible illumination boundaries and select a boundary based on both region area and spatial coherence.

In 318, mask generation 122 outputs the illumination boundary. Performing the output can include outputting the selected illumination boundary threshold, a classification map generated using the selected illumination boundary threshold, region identifiers for the illumination region and the further illumination region, statistics associated with the selected threshold, or a combination thereof. In some examples, the output of 318 is provided to generate a smooth correction mask in 210, as illustrated in FIG. 2, so that a three-part function can be applied to luminance values using transition points defined based on the illumination boundary threshold. By selecting the illumination boundary using candidate threshold evaluation, zone area filtering, and an adjacent cell gradient metric, method 300 can provide a lightweight and spatially informed boundary detection process for scene-adaptive illumination balancing.

In some examples, one or more portions of method 300 can be parameterized based on a type of scene indicated by content type detection 152, as illustrated in FIG. 1. For example, a range of candidate luminance thresholds, a step size between candidate luminance thresholds, a lower zone area threshold, an upper zone area threshold, a neighborhood pattern for adjacent cell comparisons, a weighting applied to adjacent cell differences, or a criterion for selecting the illumination boundary threshold based on the aggregate gradient metric can be selected based on whether image data corresponds to a portrait scene, a landscape scene, an indoor scene having a bright window, a backlit scene, a low-light scene, a high-dynamic-range scene, or a scene having strong directional shadows. In a portrait scene, method 300 may use parameters that favor a stable illumination boundary near a detected face region. In a landscape scene, method 300 may use parameters that favor larger, spatially coherent illumination regions. In an indoor-window scene or backlit scene, method 300 may use parameters that evaluate a broader threshold range to detect a stronger separation between a darker illumination region and a brighter further illumination region. Parameterizing method 300 based on scene type can allow mask generation 122 to identify illumination boundaries using the same threshold evaluation framework while adapting sensitivity, stability, and spatial coherence to different image content conditions.

The aggregate gradient metric can distinguish between candidate luminance thresholds that produce similar numbers of cells in each illumination region but different spatial arrangements of those cells. For example, a first candidate luminance threshold may classify the luminance grid into one compact darker illumination region adjacent to one compact brighter further illumination region. A second candidate luminance threshold may classify a similar number of cells as darker cells and brighter cells, but with the darker cells scattered across the luminance grid. The first candidate luminance threshold can have a lower aggregate gradient metric because fewer adjacent cell pairs have different thresholded values. Selecting the illumination boundary threshold based on the aggregate gradient metric can therefore favor a spatially coherent illumination boundary.

The aggregate gradient metric is spatial in nature. A histogram-based thresholding process can evaluate how many cells have different luminance values but may not directly evaluate where those cells are located in the luminance grid. In contrast, the aggregate gradient metric evaluates adjacency relationships after thresholding. Accordingly, illumination balancing 160 can select a candidate luminance threshold that not only separates darker and brighter cells but also produces a useful spatial separation for generating a correction mask and a correction table.

In some examples, selecting the illumination boundary threshold based on the aggregate gradient metric includes selecting the candidate luminance threshold having a minimum aggregate gradient metric among candidate luminance thresholds that satisfy one or more zone area criteria. The zone area criteria can prevent selection of a candidate luminance threshold that produces a very small illumination region, a very small further illumination region, or an illumination region split that is not meaningful for correction table generation. The aggregate gradient metric can then be used to select, from candidate luminance thresholds that produce acceptable region sizes, the candidate luminance threshold that provides a spatially coherent boundary.

In some examples, the aggregate gradient metric can be normalized based on a number of adjacent cell pairs evaluated in the luminance grid. Normalizing the aggregate gradient metric can allow comparison across different luminance grid sizes, cropped image regions, sensor modes, binned modes, and statistics configurations. In some examples, one or more adjacent cell pairs are omitted from the aggregate gradient metric when a cell has invalid statistics, saturated statistics, low-confidence statistics, or statistics excluded from illumination analysis.

In some examples, adjacent cells used to compute the aggregate gradient metric include horizontally adjacent cells, vertically adjacent cells, diagonally adjacent cells, or cells identified by a selected neighborhood pattern. The selected neighborhood pattern can be fixed or can be selected based on parameters 154 as illustrated in FIG. 1, a scene type indicated by content type detection 152 as illustrated in FIG. 1, a detected object region from salient object detection 150 as illustrated in FIG. 1, or a sensor mode. Using different neighborhood patterns can adjust sensitivity to different boundary orientations and spatial patterns in the luminance grid.

In some examples, absolute differences between thresholded values of adjacent cells can be weighted before being accumulated into the aggregate gradient metric. A weight can be based on a position of an adjacent cell pair in the luminance grid, a confidence value associated with one or both cells, a distance from a detected object region, a distance from an image border, or a content type indicated by content type detection 152 as illustrated in FIG. 1. Weighting the absolute differences can allow illumination balancing 160 to favor an illumination boundary that is more suitable for a particular scene type, salient object location, or image quality target.

The aggregate gradient metric can provide a computationally efficient threshold-selection process. In some examples, the metric can be computed using comparisons, subtraction, absolute-value operations, and accumulation over a lower-resolution luminance grid. The process need not compute a full-resolution gradient map, a full-resolution segmentation mask, or per-pixel local tone-mapping statistics. This can allow illumination balancing 160 as illustrated in FIG. 1 to select an illumination boundary threshold quickly and with low memory bandwidth, which is useful when modified LSC table 164 as illustrated in FIG. 1 is computed for a subsequent frame in a real-time imaging pipeline.

### Applying a Three-Part Function to Luminance Values

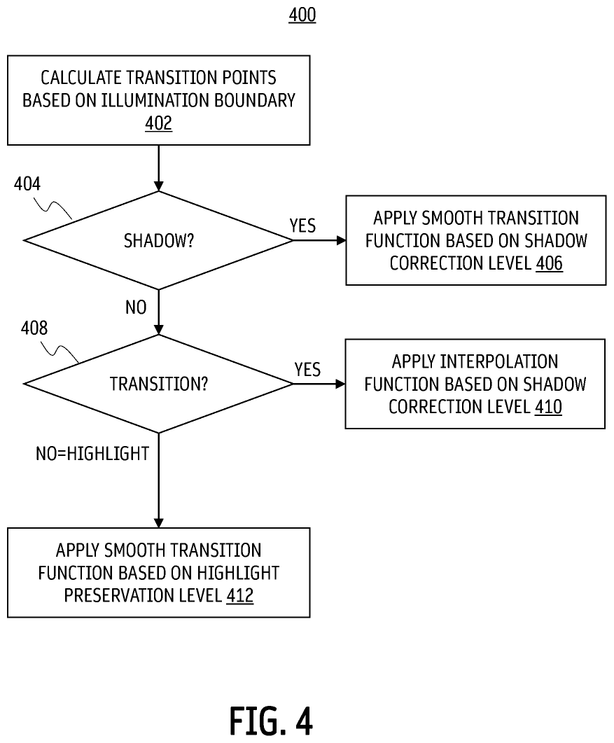

FIG. 4 is a flowchart illustrating method 400 for generating a smooth correction mask based on the illumination boundary, according to some examples of the disclosure. Method 400 can correspond to generating a smooth correction mask in 210 of method 200, as illustrated in FIG. 2. Method 400 can be performed by mask generation 122 of illumination balancing 160, as illustrated in FIG. 1. In some examples, method 400 generates a spatial correction map by applying a three-part function to luminance values. In some examples, method 400 generates a correction mask that assigns a first range of correction values to an illumination region, a second range of correction values to a further illumination region, and a smooth transition between the first range and the second range. In some examples, method 400 generates a multiplier map that can later be scaled by a correction strength, resized by resize 124, and combined with LSC table 162 by table enhancement 126, as illustrated in FIG. 1.

As used herein, a correction mask can refer to a spatial correction map, gain map, multiplier map, weight map, attenuation map, blending map, or table-compatible representation that indicates an amount of illumination balancing to be applied across image data or across a correction table.

As used herein, a shadow correction level can refer to a correction mask value, multiplier level, gain level, weighting level, or target correction level associated with a darker illumination region. As used herein, a highlight preservation level can refer to a correction mask value, multiplier level, gain level, weighting level, or target correction level associated with a brighter further illumination region. These levels may be selected so that an illumination region can receive stronger illumination balancing while a further illumination region is preserved, partially preserved, or corrected less strongly.

In 402, mask generation 122 calculates transition points based on an illumination boundary. Performing 402 can include receiving an illumination boundary threshold output by method 300, as illustrated in FIG. 3, and defining a lower transition point and an upper transition point around the illumination boundary threshold. In some examples, 402 defines a transition interval centered on the illumination boundary threshold. In some examples, 402 defines the transition interval using a smoothness width. In some examples, 402 defines transition points using one or more of a tunable parameter, a scene type parameter from content type detection 152, a correction strength parameter, a statistics confidence parameter, or a detected object parameter from salient object detection 150, as illustrated in FIG. 1. At an implementation level, 402 may be represented as:

transition_point_1 = boundary_threshold − (smoothness_width /
2)
transition_point_2 = boundary_threshold + (smoothness_width /
2)

In 404, mask generation 122 determines whether a luminance value is in a shadow range. Performing 404 can include comparing a pixel brightness, cell luminance value, normalized luminance value, or grid value to the lower transition point calculated in 402. In some examples, a value below the lower transition point is classified as corresponding to the darker illumination region. In some examples, a value below the lower transition point is processed using a shadow-side portion of a three-part function. In some examples, 404 is performed for each cell of the low-resolution luminance grid, for each value of an interpolated luminance map, or for each value used to generate the correction mask. At an implementation level, 404 may be represented as:

IF pixel_brightness < transition_point_1 THEN
process shadow-side portion

In 406, mask generation 122 applies a smooth transition function based on a shadow correction level. Performing 406 can include calculating a correction mask value using a curved portion below the lower transition point. In some examples, the curved portion gradually approaches the shadow correction level as luminance moves deeper into the darker illumination region. In some examples, the curved portion reduces abrupt changes between strongly corrected shadow values and values near the illumination boundary. In some examples, the curved portion is implemented using a square-root function, polynomial function, lookup table, piecewise curve, spline, exponential curve, or trained function. At an implementation level, 406 may be represented as: \

high_correction_value = shadow_correction_level
ratio = pixel_brightness / transition_point_1
mask_value = SQRT(1 − ratio) * (1 − high_correction_value) +
high_correction_value

The curved shadow-side portion can provide stronger correction for darker cells while avoiding a hard step at the lower transition point.

In 408, mask generation 122 determines whether a luminance value is in a transition range. Performing 408 can include determining whether the luminance value is between the lower transition point and the upper transition point. In some examples, the transition range corresponds to luminance values near the illumination boundary threshold. In some examples, the transition range corresponds to a region in which cells may be near a boundary between an illumination region and a further illumination region. In some examples, the width of the transition range can be increased to make the correction mask smoother or decreased to make the correction mask more selective. If the luminance value is in the transition range, method 400 proceeds to 410. If the luminance value is not in the transition range, the luminance value is treated as being in a highlight range and method 400 proceeds to 412.

In 410, mask generation 122 applies an interpolation function based on the shadow correction level. Performing 410 can include calculating a correction mask value using a linear transition portion between the lower transition point and the upper transition point. In some examples, the interpolation function transitions between the shadow correction level and the highlight preservation level. In some examples, the interpolation function blends correction values so that mask values change gradually near the illumination boundary. In some examples, the interpolation function is linear, piecewise linear, monotonic, table-based, or content-dependent. At an implementation level, 410 may be represented as:

mask_value = LINEAR_INTERPOLATE(pixel_brightness,
transition_point_1, transition_point_2,
high_correction_value, low_correction_value)

The interpolation function can reduce visible halos and boundary artifacts by avoiding an abrupt change between shadow correction and highlight preservation.

In 412, mask generation 122 applies a smooth transition function based on a highlight preservation level. Performing 412 can include calculating a correction mask value using a further curved portion above the upper transition point. In some examples, the further curved portion gradually approaches the highlight preservation level as luminance moves deeper into the brighter further illumination region. In some examples, the further curved portion reduces correction applied to highlights so that brighter regions are preserved relative to darker regions. In some examples, the further curved portion is implemented using a square-root function, polynomial function, lookup table, piecewise curve, spline, exponential curve, or trained function. At an implementation level, 412 may be represented as:

low_correction_value = highlight_preservation_level
ratio = (pixel_brightness − transition_point_2) / (1 −
transition_point_2)
mask_value = −low_correction_value * SQRT(ratio) +
low_correction_value

The highlight-side portion can prevent over-enhancement of bright regions and can preserve contrast in portions of the image that already have sufficient illumination.

The three branches shown in FIG. 4 can implement a three-part function. In some examples, the three-part function includes a curved portion below a lower transition point, a linear transition portion between the lower transition point and an upper transition point, and a further curved portion above the upper transition point. In some examples, the same three-part framework can be implemented using different mathematical curves, lookup tables, learned functions, or parameterized functions while preserving the relationship among a shadow range, a transition range, and a highlight range. In some examples, the output mask values are clipped, normalized, smoothed spatially, scaled by adaptive correction strength in 214, or limited based on a maximum enhancement limit before being used to generate the final mask in 216, as illustrated in FIG. 2.

In some examples, one or more portions of method 400 can be parameterized based on a scene type indicated by content type detection 152, as illustrated in FIG. 1. For example, a smoothness width used to calculate the lower transition point and the upper transition point in 402, a shadow correction level used in 406, an interpolation slope or interpolation range used in 410, a highlight preservation level used in 412, and a curve type used for one or more portions of the three-part function can be selected based on whether image data corresponds to a portrait scene, a landscape scene, an indoor scene having a bright window, a backlit scene, a low-light scene, a high-dynamic-range scene, or a scene having strong directional shadows. Different curve types may include square-root curves, polynomial curves, spline curves, exponential curves, lookup table curves, learned curves, piecewise linear curves, or parameterized sigmoid curves. In a portrait scene, method 400 may use a wider transition range and a more gradual curve to reduce abrupt luminance changes across skin regions. In a landscape scene, method 400 may use a curve that more strongly preserves highlights to maintain contrast in bright sky regions. In a backlit scene or indoor-window scene, method 400 may use a curve that provides stronger shadow correction while maintaining a smooth transition near the illumination boundary. Parameterizing method 400 based on scene type can allow mask generation 122 to use the same general three-part function framework while adapting shadow correction, transition smoothness, highlight preservation, and curve shape to different image content conditions.

Method 400 can provide one or more technical advantages. In some examples, method 400 uses luminance values and an illumination boundary threshold to produce a correction mask that targets darker regions while preserving brighter regions. In some examples, method 400 provides a gradual luminance-dependent transition that reduces hard edges, halos, banding, and visible discontinuities near an illumination boundary. In some examples, method 400 produces a compact correction mask that can be generated from low-resolution image statistics and later combined with a base correction table, allowing illumination balancing 160 to reuse lens shading correction 112 with little to no extra hardware overhead, as illustrated in FIG. 1.

### Refining a Correction Region Using a Detected Object Region

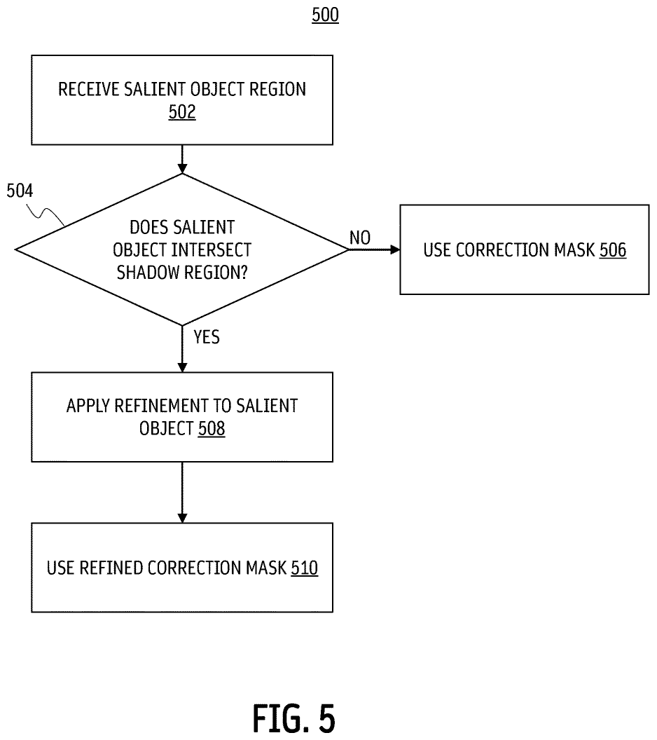

FIG. 5 is a flowchart illustrating method 500 for handling one or more detected salient objects, according to some examples of the disclosure. Method 500 can correspond to salient object refinement in 212 of method 200, as illustrated in FIG. 2. Method 500 can be performed by mask generation 122 of illumination balancing 160, as illustrated in FIG. 1. Method 500 can refine a correction mask generated from luminance-based illumination analysis using information about a detected salient object. As used herein, a salient object region can refer to a region identified by a detector as corresponding to a face, body, foreground subject, object of interest, bounding box, segmentation mask, confidence map, coordinate set, or object-location representation. As used herein, a shadow region can refer to a region of the correction mask, luminance grid, image data, or spatial correction map associated with a darker illumination region for which illumination balancing correction is applied or increased.

In 502, mask generation 122 receives a salient object region. Performing 502 can include receiving the salient object region from salient object detection 150, as illustrated in FIG. 1. In some examples, the salient object region includes face coordinates, a face bounding box, a face segmentation mask, person coordinates, a subject mask, coordinates of a foreground object, or a confidence map indicating a probability that locations correspond to a salient object. In some examples, the salient object region is mapped from an image data coordinate system to a coordinate system of the correction mask, the luminance grid, or LSC table 162. This mapping can allow object-aware refinement to be applied to the spatial representation used to generate modified LSC table 164, as illustrated in FIG. 1.

In 504, mask generation 122 determines whether the salient object region intersects a shadow region. Performing 504 can include comparing the salient object region with a correction region of the correction mask. In some examples, the correction region corresponds to cells or locations classified as part of a darker illumination region using method 300, as illustrated in FIG. 3. In some examples, the correction region corresponds to locations of the correction mask having correction values that satisfy a threshold, locations associated with shadow enhancement, or locations that would receive stronger correction than a brighter further illumination region. Determining whether the salient object region intersects the shadow region can identify situations in which luminance-based correction may apply different correction treatment to different portions of the same salient object.

If the salient object region does not intersect the shadow region, method 500 proceeds to 506, and mask generation 122 uses the correction mask. Performing 506 can include outputting the correction mask generated by method 400, as illustrated in FIG. 4, without salient object refinement. In some examples, using the correction mask includes providing the correction mask for adaptive correction strength computation in 214, final mask generation in 216, resize 124, or table enhancement 126, as illustrated in FIGS. 1 and 2. This path can avoid unnecessary object-aware processing when the salient object is outside the darker illumination region or when the luminance-based correction mask already provides consistent correction for the salient object.

If the salient object region intersects the shadow region, method 500 proceeds to 508, and mask generation 122 applies refinement of the correction mask according to the salient object. Performing 508 can include modifying the correction mask by extending or reshaping a correction region based on the salient object region. In some examples, the correction region is expanded to include a larger portion of the salient object region. In some examples, a boundary of the correction region is smoothed, regularized, made more convex, or reshaped within the salient object region. In some examples, correction values within the salient object region are adjusted to provide a smoother or more monotonic illumination gradient across the salient object region. At an implementation level, 508 may be represented as:

IF salient_object_intersects_shadow_region THEN
refined_correction_mask =
APPLY_SALIENT_OBJECT_REFINEMENT(correction_mask,
salient_object_region)
END_IF

In some examples, applying refinement to the salient object in 508 can include face-aware refinement. For example, if a face region intersects the shadow region, mask generation 122 can adjust the correction mask so that the face region is treated more coherently by illumination balancing 160. This can include extending the correction region over a face bounding box, reshaping the correction region using a segmentation mask, applying a convex morphological adjustment within the face region, smoothing correction mask values across the face region, or reducing abrupt changes in correction strength across skin regions. Such refinement can reduce unnatural brightness steps on a face when only part of the face initially falls within a darker illumination region.

In some examples, the refinement applied in 508 changes the correction mask rather than directly changing final rendered pixels. The refined correction mask can subsequently be scaled, resized, and combined with LSC table 162 to generate modified LSC table 164, as illustrated in FIG. 1. Applying object-aware refinement at the mask or table generation stage can allow lens shading correction 112 to apply the resulting correction using the same correction table infrastructure used for lens shading correction. This can provide content-aware illumination balancing while preserving the hardware-efficiency benefits of applying correction through a pixel correction circuit.

In 510, mask generation 122 uses the refined correction mask. Performing 510 can include outputting the refined correction mask for later operations of method 200, as illustrated in FIG. 2. In some examples, the refined correction mask is used to compute adaptive correction strength in 214, generate mask in 216, resize a spatial correction map to a size of LSC table 162, or generate modified LSC table 164 using table enhancement 126, as illustrated in FIG. 1. Using the refined correction mask can improve visual consistency for salient objects while still allowing the correction mask to be derived from low-resolution luminance statistics.

In some examples, one or more portions of method 500 can be parameterized based on a scene type indicated by content type detection 152, as illustrated in FIG. 1. For example, an object type used to define the salient object region in 502, an intersection threshold used in 504, a shadow region threshold used in 504, a minimum overlap amount used to trigger refinement, a refinement strength used in 508, a shape constraint used in 508, a smoothing amount used in 508, or a weighting applied to correction mask values within the salient object region can be selected based on whether image data corresponds to a portrait scene, a group-photo scene, a landscape scene, an indoor scene having a bright window, a backlit scene, a low-light scene, a high-dynamic-range scene, or a scene having strong directional shadows. In a portrait scene, method 500 may use parameters that trigger refinement when a face region partially intersects a shadow region, so that correction values across the face region are more coherent. In a group-photo scene, method 500 may use parameters that refine multiple face regions or prioritize a face region having a higher detection confidence. In a landscape scene, method 500 may reduce or disable salient object refinement when no foreground subject is detected. In a backlit scene or indoor-window scene, method 500 may increase refinement strength for a foreground subject located in a darker illumination region. Parameterizing method 500 based on scene type can allow mask generation 122 to adapt object-aware correction mask refinement to image content while preserving the luminance-based illumination balancing framework. In some examples, method 500 may be invoked or disabled depending on the scene type.

Method 500 can provide one or more technical advantages. Luminance-based mask generation can identify darker and brighter illumination regions efficiently, but a salient object may partially overlap a darker region and partially overlap a brighter region. Without refinement, different portions of the same salient object may receive noticeably different correction levels. By determining whether the salient object region intersects the shadow region and refining the correction mask when an intersection exists, method 500 can improve perceived naturalness, reduce abrupt correction changes across salient objects, and support more coherent illumination balancing for faces and foreground subjects.

### Determining Adaptive Correction Strength

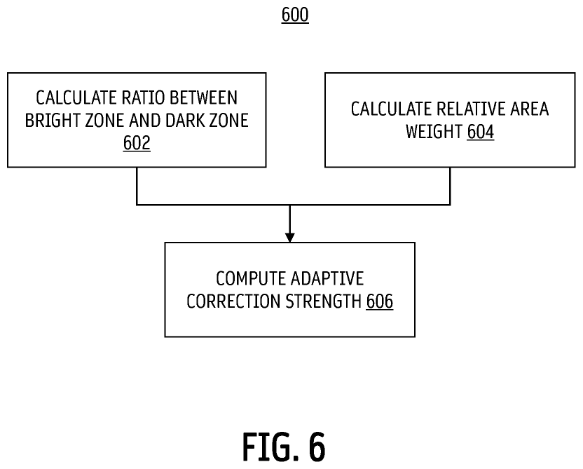

FIG. 6 is a flowchart illustrating method 600 for determining an adaptive correction strength, according to some examples of the disclosure. Method 600 can correspond to compute adaptive correction strength in 214 of method 200, as illustrated in FIG. 2. Method 600 can be performed by mask generation 122 or illumination balancing 160, as illustrated in FIG. 1. Method 600 can determine how strongly a correction mask should affect generation of modified LSC table 164. Rather than applying a fixed correction amount whenever an illumination boundary is detected, method 600 can scale correction according to scene characteristics so that mild illumination imbalance produces mild correction and severe illumination imbalance produces stronger correction.

As used herein, adaptive correction strength can refer to a scalar, coefficient, multiplier, weight, map, function output, or set of values that controls an amount of illumination balancing applied using a correction mask. Adaptive correction strength may be applied to a smooth correction mask generated by method 400, as illustrated in FIG. 4, before the correction mask is resized and combined with LSC table 162. In some examples, adaptive correction strength is calculated once per frame, once per table update, once per detected illumination condition, or according to a periodic or triggered update schedule. Adaptive correction strength can allow illumination balancing 160 to respond to the severity of a scene while still using a compact correction mask generated from low-resolution image statistics.

In 602, illumination balancing 160 calculates a ratio between a bright zone and a dark zone. Performing 602 can include determining an average luminance of a brighter further illumination region, determining an average luminance of a darker illumination region, and calculating a brightness ratio between the regions. In some examples, the bright zone and the dark zone are identified using illumination boundary threshold in 318 output by method 300, as illustrated in FIG. 3. In some examples, saturated cells, overexposed cells, invalid cells, or low-confidence cells are excluded when calculating average luminance values. At an implementation level, 602 may include:

bright_avg = bright_sum / bright_count
dark_avg = dark_sum / dark_count
brightness_ratio = bright_avg / dark_avg

The brightness ratio can indicate how different the illumination conditions are between the brighter and darker regions of the scene.

The ratio calculated in 602 can be converted into a brightness ratio weight. In some examples, the brightness ratio weight is zero below an activation start point, increases between the activation start point and a brightness ratio threshold, and is limited by a maximum coefficient value. In some examples, the brightness ratio weight increases linearly over a first range and according to a curved function over a second range. At an implementation level, the brightness ratio weight may be represented as:

```
IF brightness_ratio < start_point THEN
  brightness_ratio_weight = 0
ELSE IF brightness_ratio <= threshold_THEN
  brightness_ratio_weight = (brightness_ratio −
start_point) / (threshold − start_point)
ELSE
  brightness_ratio_weight = CURVE(brightness_ratio)
  brightness_ratio_weight = MIN(brightness_ratio_weight,
max_value)
```

This weighting can prevent unnecessary enhancement when the bright and dark zones are not meaningfully different, while allowing stronger correction when the illumination imbalance is pronounced.

In 604, illumination balancing 160 calculates a relative area weight. Performing 604 can include determining an area of the dark zone relative to a total area represented by the luminance grid. In some examples, the relative area weight is based on a number of cells classified as part of the darker illumination region divided by a total number of cells in the luminance grid. In some examples, the relative area weight is zero when the darker illumination region is smaller than an activation start point, increases across an area transition range, and reaches a full weighting value when the darker illumination region satisfies an area threshold. At an implementation level, 604 may include:

```
dark_area = dark_count / (luminance_grid.width *
luminance_grid.height)
IF dark_area < start_point THEN
  area_weight = 0
ELSE IF dark_area <= threshold THEN
  area_weight = (dark_area − start_point) / (threshold −
start_point)
ELSE
area_weight = 1
```

The relative area weight can reduce correction when the darker region is too small to justify modifying LSC table 162.

The relative area weight calculated in 604 can provide a gradual activation behavior. For example, if the darker illumination region occupies a very small percentage of the luminance grid, applying a strong correction may amplify noise, overemphasize a small shadow, or create an unnatural local change in the image. If the darker illumination region occupies a meaningful portion of the luminance grid, stronger correction may improve image quality because the scene more likely includes a substantial illumination imbalance. A transition range for the relative area weight can reduce visible jumps between frames by allowing correction strength to ramp up gradually as the dark zone area approaches an activation threshold.

In 606, illumination balancing 160 computes the adaptive correction strength based on the ratio between the bright zone and the dark zone and the relative area weight. Performing 606 can include combining a brightness ratio weight, an area weight, and a base correction strength. In some examples, 606 computes adaptive correction strength by multiplying the brightness ratio weight, the area weight, and a configurable power value. At an implementation level, 606 may include:

correction_strength = brightness_ratio_weight * area_weight *
base_correction_strength

In some examples, correction strength is limited using a maximum enhancement limit. Limiting correction strength can reduce noise amplification, saturation, and artificial-looking changes that may occur if dark region enhancement is too strong.

Method 600 can be parameterized using parameters 154, as illustrated in FIG. 1. For example, a brightness ratio activation start point, a brightness ratio threshold, a maximum coefficient value, a dark-area threshold, an area transition width, a base correction strength, and a maximum enhancement limit can be configurable. These parameters may be fixed for a product configuration, selected based on a capture mode, selected based on a scene type from content type detection 152, or adjusted based on tuning data. In a portrait scene, parameters may favor gradual activation to maintain natural skin appearance. In a backlit scene, parameters may allow stronger correction when the subject is in a darker illumination region. In a landscape scene, parameters may favor more conservative correction to preserve contrast in bright sky or highlight regions.

Method 600 can provide one or more technical advantages. By using either or both brightness ratio and relative area weight, method 600 can distinguish between a scene having a small dark detail and a scene having a large under-illuminated region. Method 600 can also distinguish between a scene having mild illumination variation and a scene having severe backlighting or shadowing. Combining these factors can reduce overcorrection in mild scenes, reduce unnecessary correction in scenes with small dark regions, and provide stronger correction when a darker illumination region is both large enough and sufficiently darker than a brighter further illumination region. This adaptive behavior can improve visual quality while allowing illumination balancing 160 to remain computationally lightweight.

Computing a Correction Table from Image Statistics and Applying Illumination Balancing Using a Correction Table

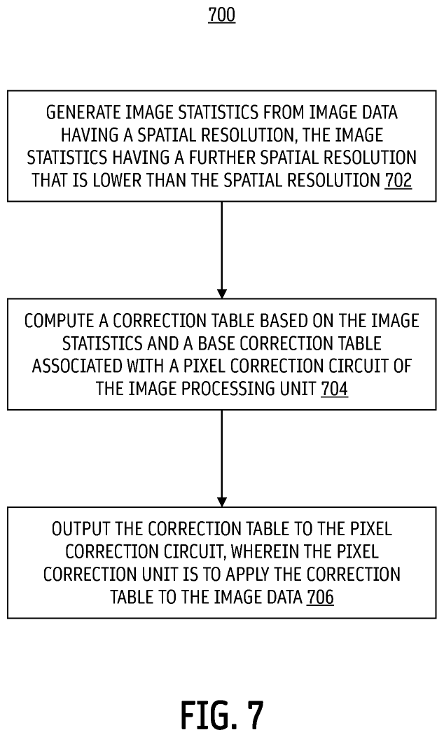

FIG. 7 is a flowchart illustrating method 700 for implementing illumination balancing, according to some examples of the disclosure. Method 700 can be performed by image processing unit 190, as illustrated in FIG. 1. In some examples, method 700 can be performed by one or more processors executing instructions stored on one or more non-transitory computer-readable media. In some examples, method 700 can be performed by firmware, software, hardware logic, fixed-function circuitry, programmable circuitry, or a combination of hardware and firmware. Method 700 can implement illumination balancing by generating low-resolution image statistics, computing a correction table from the image statistics and a base correction table, and outputting the correction table to a pixel correction circuit.

In 702, image processing unit 190 generates image statistics from image data having a spatial resolution, the image statistics having a further spatial resolution that is lower than the spatial resolution. Performing 702 can include receiving image data from sensor 102, as illustrated in FIG. 1, and generating lower-resolution statistics using statistics engine 120. In some examples, the image statistics include a luminance grid. In some examples, the luminance grid is generated from RGBS statistics, color-channel statistics, saturation statistics, exposure statistics, auto-exposure statistics, or statistics produced by an image statistics engine. Generating image statistics at the further spatial resolution can allow illumination balancing 160 to analyze broad illumination patterns without processing every pixel of the image data for boundary detection and mask generation.

In some examples, the image statistics generated in 702 are derived from a frame, and a correction table computed using the image statistics is applied to a further frame subsequent to the frame. For example, statistics engine 120 can generate lower-resolution image statistics while image processing unit 190 processes a current frame, and illumination balancing 160 can compute modified LSC table 164 for a next frame or a later frame. In some examples, illumination balancing 160 computes the correction table periodically, after a predetermined number of frames, in response to detecting a change in scene content, in response to detecting a change in illumination distribution, in response to detecting motion or exposure change, in response to information from salient object detection 150, in response to information from content type detection 152, or based on a table update trigger.

In 704, image processing unit 190 computes a correction table based on the image statistics and a base correction table associated with a pixel correction circuit of image processing unit 190. Performing 704 can include illumination balancing 160 computing modified LSC table 164 based on LSC table 162 and image statistics received from statistics engine 120, as illustrated in FIG. 1. In some examples, the pixel correction circuit comprises lens shading correction 112, and the base correction table comprises LSC table 162, which may be a base lens shading correction table to compensate for optical lens shading. In this manner, method 700 can preserve calibrated lens shading correction while adding scene-adaptive illumination balancing through table modification.

In some examples, computing the correction table in 704 includes generating a spatial correction map from the image statistics and combining the spatial correction map with the base correction table. Generating the spatial correction map can include identifying, from the image statistics, an illumination region and a further illumination region, the illumination region being darker than the further illumination region. In some examples, illumination balancing 160 evaluates a plurality of candidate luminance thresholds, selects one candidate luminance threshold as an illumination boundary threshold, and classifies cells of a luminance grid as part of the illumination region or the further illumination region using the illumination boundary threshold.

In some examples, selecting the illumination boundary threshold includes assigning thresholded values to cells of the luminance grid based on whether luminance values of the cells satisfy a candidate luminance threshold. Illumination balancing 160 can compute an aggregate gradient metric based on absolute differences between the thresholded values of adjacent cells of the luminance grid and select the illumination boundary threshold based on the aggregate gradient metric. This spatial threshold-selection process can favor an illumination boundary that separates spatially coherent illumination regions, instead of selecting a threshold based only on luminance histogram variance.

In some examples, computing the correction table in 704 includes applying a no-activation criterion. If the image statistics satisfy the no-activation criterion, illumination balancing 160 can output the base correction table as the correction table. The no-activation criterion can be satisfied based on one or more of a brightness ratio between an illumination region and a further illumination region failing to satisfy a threshold, an area of the illumination region failing to satisfy a minimum area threshold, a relative area weight failing to satisfy a threshold, a candidate luminance threshold failing to produce a meaningful split between the illumination region and the further illumination region, a scene being substantially uniformly illuminated, a correction strength having a zero value, or an illumination balancing enable parameter indicating that illumination balancing is disabled.

In some examples, computing the correction table in 704 includes applying a three-part function to luminance values to generate the spatial correction map. The three-part function can include a curved portion below a lower transition point, a linear transition portion between the lower transition point and an upper transition point, and a further curved portion above the upper transition point. The lower transition point and the upper transition point can be defined based on an illumination boundary threshold. This can allow the spatial correction map to provide stronger correction in a darker illumination region, preserve a brighter further illumination region, and provide a smooth transition near an illumination boundary.

In some examples, computing the correction table in 704 includes modifying the spatial correction map based on a detected object region. For example, illumination balancing 160 can modify the spatial correction map by extending or reshaping a correction region of the spatial correction map based on a detected object region intersecting the correction region. The detected object region can correspond to a face region, body region, foreground subject region, bounding box, segmentation mask, confidence map, or object-location representation. In some examples, illumination balancing 160 determines a correction strength for illumination balancing based on one or more of a brightness ratio between the illumination region and the further illumination region and a relative area weight between the illumination region and the further illumination region. Illumination balancing 160 can also limit a correction multiplier used to compute the correction table based on a maximum enhancement limit.

In some examples, computing the correction table in 704 includes resizing the spatial correction map to a size of the base correction table and performing elementwise multiplication of values of a resized version of the spatial correction map with values of the base correction table. For example, resize 124 can resize the spatial correction map to a size of LSC table 162, and table enhancement 126 can multiply resized spatial correction map values with corresponding values of LSC table 162 to generate modified LSC table 164, as illustrated in FIG. 1. Such resizing and elementwise multiplication can allow a mask generated from low-resolution image statistics to be converted into a table-compatible correction format.

In 706, image processing unit 190 outputs the correction table to the pixel correction circuit, and the pixel correction circuit applies the correction table to the image data. Performing 706 can include outputting modified LSC table 164 to lens shading correction 112, as illustrated in FIG. 1. Lens shading correction 112 can apply modified LSC table 164 to image data before lower bit depth and/or downsampling 114. Applying the correction table upstream of bit depth reduction or downsampling can preserve dynamic range and spatial detail during illumination balancing. Method 700 can therefore provide illumination balancing using lower-resolution image statistics and an existing pixel correction circuit, reducing computation, bandwidth, power, and hardware overhead relative to full-resolution correction processing.

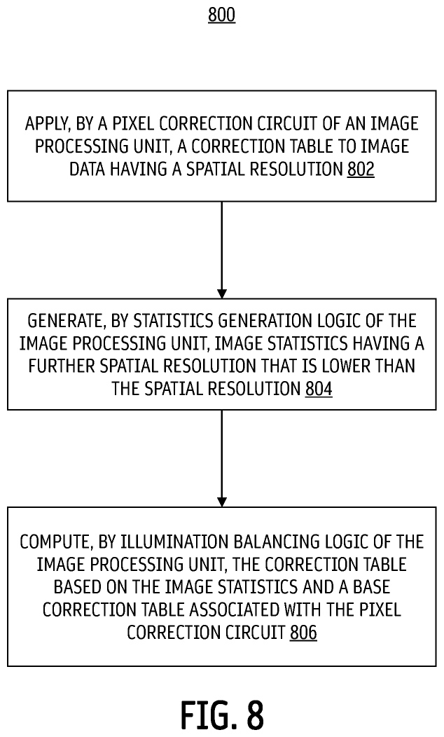

FIG. 8 is a flowchart illustrating method 800 for implementing illumination balancing, according to some examples of the disclosure. Method 800 can be performed by image processing unit 190, as illustrated in FIG. 1. In some examples, method 800 can be performed by hardware, firmware, software, one or more processors executing instructions stored on one or more non-transitory computer-readable media, fixed-function circuitry, programmable circuitry, or a combination of hardware and firmware. Method 800 can apply a correction table to image data, generate lower-resolution image statistics, and compute the correction table using the image statistics and a base correction table associated with a pixel correction circuit.

In 802, a pixel correction circuit of image processing unit 190 applies a correction table to image data having a spatial resolution. Performing 802 can include lens shading correction 112 applying modified LSC table 164 to image data received from sensor 102 after linearization 110, as illustrated in FIG. 1. In some examples, the pixel correction circuit comprises lens shading correction 112, and the correction table comprises modified LSC table 164. In some examples, the correction table includes spatially varying values, gains, multipliers, or table entries applied to the image data. Lens shading correction 112 can apply the correction table to compensate for optical lens shading and to provide scene-adaptive illumination balancing.

In some examples, 802 is performed upstream of lower bit depth and/or downsampling 114, as illustrated in FIG. 1. Image processing unit 190 can therefore perform bit depth reduction or downsampling downstream of the pixel correction circuit. Applying the correction table before lower bit depth and/or downsampling 114 can allow illumination balancing to be applied when image data has greater dynamic range, greater spatial resolution, or more sensor-level information than image data available later in the pipeline. This can improve correction quality while allowing downstream processing 116 to operate using an image that has already been illumination-balanced.

In 804, statistics generation logic of image processing unit 190 generates image statistics having a further spatial resolution that is lower than the spatial resolution of the image data. Performing 804 can include statistics engine 120 generating the image statistics, as illustrated in FIG. 1. In some examples, the image statistics comprise a luminance grid. In some examples, the luminance grid is directly generated by statistics engine 120. In some examples, the luminance grid is derived from RGBS statistics, color-channel statistics, saturation statistics, exposure statistics, auto-exposure statistics, or statistics available in image processing unit 190. Generating image statistics at the further spatial resolution can reduce computation, memory bandwidth, and power relative to analyzing the full-resolution image data.

In some examples, image statistics generated in 804 are derived from a frame, and a correction table computed based on the image statistics is computed for a further frame subsequent to the frame. For example, statistics engine 120 can collect image statistics during processing of a current frame, and illumination balancing 160 can compute modified LSC table 164 for a next frame or a later frame. In some examples, the correction table is computed for every frame, periodically, after a predetermined number of frames, in response to a change in scene content, in response to a change in illumination distribution, in response to motion, in response to an exposure change, in response to salient object detection 150, in response to content type detection 152, or in response to a table update trigger.

In 806, illumination balancing logic of image processing unit 190 computes the correction table based on the image statistics and a base correction table associated with the pixel correction circuit. Performing 806 can include illumination balancing 160 computing modified LSC table 164 based on image statistics from statistics engine 120 and LSC table 162, as illustrated in FIG. 1. In some examples, the base correction table comprises a base lens shading correction table to compensate for optical lens shading. By computing modified LSC table 164 using LSC table 162, image processing unit 190 can preserve baseline lens shading correction while adding scene-adaptive illumination balancing through existing correction table infrastructure.

In some examples, computing the correction table in 806 includes generating a spatial correction map from the image statistics and combining the spatial correction map with the base correction table. Generating the spatial correction map can include identifying, from the image statistics, an illumination region and a further illumination region, the illumination region being darker than the further illumination region. In some examples, illumination balancing 160 evaluates a plurality of candidate luminance thresholds, selects one of the candidate luminance thresholds as an illumination boundary threshold, and classifies cells of a luminance grid as part of the illumination region or the further illumination region using the illumination boundary threshold. In some examples, illumination balancing 160 assigns thresholded values to cells of the luminance grid based on whether luminance values of the cells satisfy a candidate luminance threshold, computes an aggregate gradient metric based on absolute differences between thresholded values of adjacent cells of the luminance grid, and selects the illumination boundary threshold based on the aggregate gradient metric.

In some examples, computing the correction table in 806 includes determining whether image statistics satisfy a no-activation criterion. Based on the image statistics satisfying the no-activation criterion, illumination balancing 160 can output the base correction table as the correction table. The no-activation criterion can be satisfied based on one or more of a brightness ratio between an illumination region and a further illumination region failing to satisfy a threshold, an area of the illumination region failing to satisfy a minimum area threshold, a relative area weight failing to satisfy a threshold, a candidate luminance threshold failing to produce a meaningful split between the illumination region and the further illumination region, a ratio of cells classified as the illumination region being below a lower split threshold, a ratio of cells classified as the illumination region being above an upper split threshold, a scene being substantially uniformly illuminated, a brightness ratio weight having a zero value, an area weight having a zero value, a correction strength having a zero value, a correction strength failing to satisfy a minimum strength threshold, or an illumination balancing enable parameter indicating that illumination balancing is disabled.

In some examples, computing the correction table in 806 includes generating the spatial correction map by applying a three-part function to luminance values. The three-part function can include a curved portion below a lower transition point, a linear transition portion between the lower transition point and an upper transition point, and a further curved portion above the upper transition point. The lower transition point and the upper transition point can be defined based on an illumination boundary threshold. In some examples, illumination balancing 160 determines a correction strength for illumination balancing based on one or more of a brightness ratio between the illumination region and the further illumination region and a relative area weight between the illumination region and the further illumination region. In some examples, illumination balancing 160 limits a correction multiplier used to compute the correction table based on a maximum enhancement limit.

In some examples, computing the correction table in 806 includes modifying the spatial correction map based on a detected object region. For example, illumination balancing 160 can extend or reshape a correction region of the spatial correction map based on the detected object region intersecting the correction region. The detected object region can correspond to a face region, body region, foreground subject region, bounding box, segmentation mask, confidence map, or object-location representation. Modifying the spatial correction map based on the detected object region can reduce inconsistent correction across a salient object and can improve visual consistency when a portion of the salient object intersects a darker illumination region.

In some examples, computing the correction table in 806 includes resizing the spatial correction map to a size of the base correction table and performing elementwise multiplication of values of a resized version of the spatial correction map with values of the base correction table. For example, resize 124 can resize the spatial correction map to a size of LSC table 162, and table enhancement 126 can perform elementwise multiplication to generate modified LSC table 164, as illustrated in FIG. 1. Method 800 can thereby use low-resolution image statistics to compute a scene-adaptive correction table for a pixel correction circuit, allowing illumination balancing to be applied early in the image processing pipeline with reduced computation, reduced bandwidth, and little to no additional hardware overhead.

### Example Computing Device

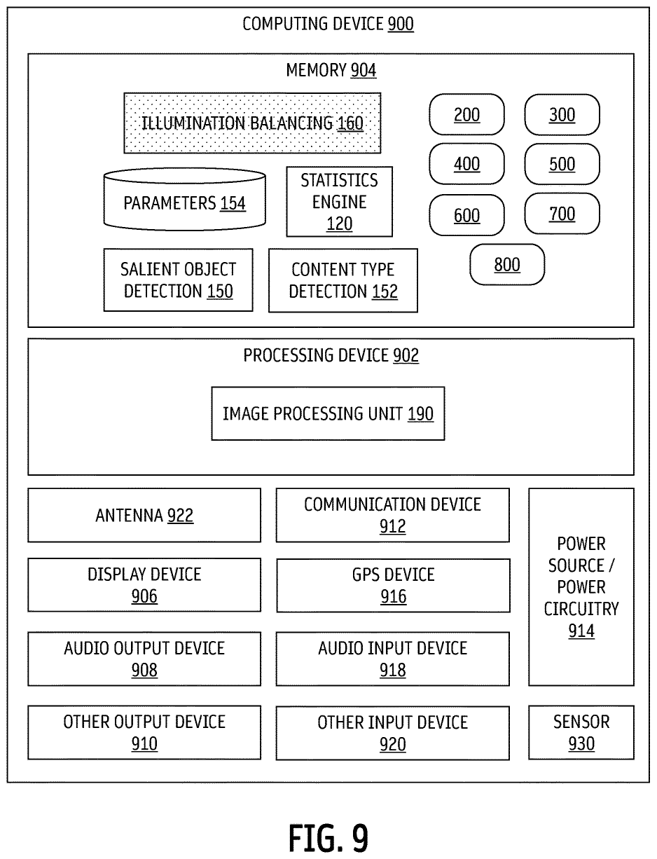

FIG. 9 is a block diagram of an apparatus or a system, e.g., an example computing device 900, according to some examples of the disclosure. One or more computing devices 900 may be used to implement the functionalities described with the FIGS. and herein. A number of components illustrated in FIG. 9 can be included in the computing device 900, but any one or more of these components may be omitted or duplicated, as suitable for the application. In some examples, some or all of the components included in the computing device 900 may be attached to one or more motherboards. In some examples, some or all of these components are fabricated onto a single system on a chip (SoC) die. Additionally, in various examples, the computing device 900 may not include one or more of the components illustrated in FIG. 9, and the computing device 900 may include interface circuitry for coupling to the one or more components. For example, the computing device 900 may not include a display device 906, and may include display device interface circuitry (e.g., a connector and driver circuitry) to which a display device 906 may be coupled. In another set of examples, the computing device 900 may not include an audio input device 918 or an audio output device 908 and may include audio input or output device interface circuitry (e.g., connectors and supporting circuitry) to which audio input device 918 or audio output device 908 may be coupled.

Computing device 900 may include processing device 902 (e.g., one or more processing devices, one or more of the same type of processing device, one or more of different types of processing devices). Processing device 902 may include electronic circuitry that processes electronic data from data storage elements (e.g., registers, memory, resistors, capacitors, quantum bit cells) to transform that electronic data into other electronic data that may be stored in registers and/or memory. Examples of processing device 902 may include a central processing unit (CPU), a graphics processing unit (GPU), an image processing unit, an image signal processor, a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a field programmable gate array (FPGA), a tensor processing unit (TPU), a neural network hardware accelerator, a deep neural network hardware accelerator, etc. Processing device 902 may have synchronization primitives/resources such as hardware barriers for synchronization operations being executed on the processing device 902.

In some examples, processing device 902 can include or be image processing unit 190, as described with reference to FIG. 1. Processing device 902 may implement one or more hardware, logic, firmware, or software components corresponding to image processing unit 190. In some examples, image processing unit 190 is a dedicated image signal processor, image processing unit, application-specific integrated circuit, or system-on-chip component to execute image processing operations. In other examples, image processing unit 190 may be implemented as one or more functional or logic blocks executed on processing device 902. Accordingly, references to operations performed by image processing unit 190 may correspond to operations performed by processing device 902, whether implemented as dedicated hardware, programmable logic, firmware, or instructions executed by processing device 902. In some examples, image processing unit 190 can be implemented as a standalone integrated circuit to perform one or more functions described herein. In some examples, image processing unit 190 can be integrated as a functional or circuit block within an SoC and as part of processing device 902, sharing resources such as memory, interconnect, and control logic with other processing components.

In some examples, memory 904 includes one or more non-transitory computer-readable media storing instructions executable to perform operations described with the FIGS. and herein. Memory 904 may include one or more non-transitory computer-readable media storing instructions executable to perform one or more operations described with method 200 of FIG. 2, method 300 of FIG. 3, method 400 of FIG. 4, method 500 of FIG. 5, method 600 of FIG. 6, method 700 of FIG. 7, or method 800 of FIG. 8. Example parts, e.g., parts illustrated as part of image processing unit 190 in FIG. 1, may be encoded as instructions and stored in memory 904. The instructions stored in the one or more non-transitory computer-readable media may be executed by processing device 902.

In some examples, memory 904 may store data, e.g., data structures, binary data, bits, metadata, files, blobs, etc., as described with the FIGS. and herein. Memory 904 may store inputs, intermediate inputs, intermediate outputs, and outputs of method 200 of FIG. 2, method 300 of FIG. 3, method 400 of FIG. 4, method 500 of FIG. 5, method 600 of FIG. 6, method 700 of FIG. 7, or method 800 of FIG. 8. Memory 904 may store raw images and processed images of imaging system 100 described and illustrated in FIG. 1.

In some examples, computing device 900 may include a communication device 912 (e.g., one or more communication devices). For example, communication device 912 may be configured for managing wired and/or wireless communications for the transfer of data to and from the computing device 900. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some examples they might not. Communication device 912 may implement any of a number of wireless standards or protocols. Computing device 900 may include antenna 922 to facilitate wireless communications and/or to receive other wireless communications (such as radio frequency transmissions). Computing device 900 may include receiver circuits and/or transmitter circuits. In some examples, communication device 912 may manage wired communications, such as electrical, optical, or any other suitable communication protocols (e.g., the Ethernet). As noted above, communication device 912 may include multiple communication chips. For instance, a first communication device 912 may be dedicated to shorter-range wireless communications. In some examples, a first communication device 912 may be dedicated to wireless communications, and a second communication device 912 may be dedicated to wired communications.

Computing device 900 may include power source/power circuitry 914. The power source/power circuitry 914 may include one or more energy storage devices (e.g., batteries or capacitors) and/or circuitry for coupling components of the computing device 900 to an energy source separate from the computing device 900 (e.g., DC power, AC power, etc.).

Computing device 900 may include a display device 906 (or corresponding interface circuitry, as discussed above). The display device 906 may include any visual indicators, such as a heads-up display, a computer monitor, a projector, a touchscreen display, a liquid crystal display (LCD), a light-emitting diode display, or a flat panel display, for example.

Computing device 900 may include audio output device 908 (or corresponding interface circuitry, as discussed above). Audio output device 908 may include any device that generates an audible indicator, such as speakers, headsets, or earbuds, for example.

Computing device 900 may include audio input device 918 (or corresponding interface circuitry, as discussed above). Audio input device 918 may include any device that generates a signal representative of a sound, such as microphones, microphone arrays, or digital instruments (e.g., instruments having a musical instrument digital interface (MIDI) output).

Computing device 900 may include GPS device 916 (or corresponding interface circuitry, as discussed above). GPS device 916 may be in communication with a satellite-based system and may receive a location of the computing device 900, as known in the art.

Computing device 900 may include sensor 930 (or one or more sensors). Computing device 900 may include corresponding interface circuitry, as discussed above). Sensor 930 may sense physical phenomenon and translate the physical phenomenon into electrical signals that can be processed by, e.g., processing device 902. Examples of sensor 930 may include: image sensor, capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 900 may include another output device 910 (or corresponding interface circuitry, as discussed above). Examples of the other output device 910 may include an audio codec, a video codec, a printer, a wired or wireless transmitter for providing information to other devices, haptic output device, gas output device, vibrational output device, lighting output device, home automation controller, or an additional storage device.

Computing device 900 may include another input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 900 may have any desired form factor, such as a handheld or mobile computer system (e.g., a cell phone, a smart phone, a mobile internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or networked computing component, a printer, a scanner, a monitor, a set-top box, an entertainment control unit, a vehicle control unit, a digital camera, a digital video recorder, an Internet-of-Things device, or a wearable computer system. In some examples, the computing device 900 may be any other electronic device that processes data.

### SELECT EXAMPLES

Example 1 provides an image processing unit, including a pixel correction circuit to apply a correction table to image data having a spatial resolution; a statistics generation logic to generate image statistics having a further spatial resolution that is lower than the spatial resolution; and an illumination balancing logic to compute the correction table based on the image statistics and a base correction table associated with the pixel correction circuit.

Example 2 provides the image processing unit of example 1, where: the pixel correction circuit includes a lens shading correction circuit; and the base correction table includes a base lens shading correction table to compensate for optical lens shading.

Example 3 provides the image processing unit of example 1 or 2, where the illumination balancing logic is to compute the correction table by: generating a spatial correction map from the image statistics; and combining the spatial correction map with the base correction table.

Example 4 provides the image processing unit of example 3, where the illumination balancing logic is to generate the spatial correction map by: identifying, from the image statistics, an illumination region and a further illumination region, the illumination region being darker than the further illumination region; and generating the spatial correction map using the illumination region and the further illumination region.

Example 5 provides the image processing unit of example 4, where the illumination balancing logic is to identify the illumination region and the further illumination region by: evaluating a plurality of candidate luminance thresholds; selecting one of the plurality of candidate luminance thresholds as an illumination boundary threshold; and classifying cells of a luminance grid as part of the illumination region or the further illumination region using the illumination boundary threshold.

Example 6 provides the image processing unit of example 5, where: the illumination balancing logic is to select the one of the plurality of candidate luminance thresholds as the illumination boundary threshold by: assigning thresholded values to cells of the luminance grid based on whether luminance values of the cells satisfy a given candidate luminance threshold; computing an aggregate gradient metric based on absolute differences between the thresholded values of adjacent cells of the luminance grid; and selecting the illumination boundary threshold based on the aggregate gradient metric.

Example 7 provides the image processing unit of any one of examples 1-6, where the illumination balancing logic is to output the base correction table as the correction table based on the image statistics satisfying a no-activation criterion.

Example 8 provides the image processing unit of any one of examples 3-7, where the illumination balancing logic is to generate the spatial correction map by: applying a three-part function to luminance values, the three-part function including a curved portion below a lower transition point, a linear transition portion between the lower transition point and an upper transition point, and a further curved portion above the upper transition point, the lower transition point and the upper transition point being defined based on an illumination boundary threshold.

Example 9 provides the image processing unit of any one of examples 1-7, where the illumination balancing logic is to compute the correction table by: generating a spatial correction map from the image statistics; modifying the spatial correction map by extending or reshaping a correction region of the spatial correction map based on a detected object region intersecting the correction region; and combining the spatial correction map with the base correction table.

Example 10 provides the image processing unit of any one of examples 1-9, where the illumination balancing logic is to: determine a correction strength for illumination balancing based on one or more of a brightness ratio between an illumination region and a further illumination region and a relative area weight between the illumination region and the further illumination region; and the illumination balancing logic computes the correction table based on the correction strength.

Example 11 provides the image processing unit of any one of examples 1-10, where the image statistics includes a luminance grid.

Example 12 provides the image processing unit of any one of examples 1-11, where the illumination balancing logic is to compute the correction table by: generating a spatial correction map from the image statistics; resizing the spatial correction map to a size of the base correction table; and performing elementwise multiplication of values of a resized version of the spatial correction map with further values of the base correction table.

Example 13 provides the image processing unit of any one of examples 1-12, further including a bit depth reduction logic or a downsampling logic downstream of the pixel correction circuit.

Example 14 provides the image processing unit of any one of examples 1-13, where the illumination balancing logic is to limit a correction multiplier used to compute the correction table based on a maximum enhancement limit.

Example 15 provides the image processing unit of any one of examples 1-14, where the image statistics are derived from a frame, and the illumination balancing logic computes the correction table for a further frame subsequent to the frame.

Example 16 provides one or more non-transitory computer-readable media storing instructions that, when executed by an image processing unit, cause the image processing unit to: generate image statistics from image data having a spatial resolution, the image statistics having a further spatial resolution that is lower than the spatial resolution; compute a correction table based on the image statistics and a base correction table associated with a pixel correction circuit of the image processing unit; and output the correction table to the pixel correction circuit, where the pixel correction circuit is to apply the correction table to the image data.

Example 17 provides the one or more non-transitory computer-readable media of example 16, where: the pixel correction circuit includes a lens shading correction circuit; and the base correction table includes a base lens shading correction table to compensate for optical lens shading.

Example 18 provides the one or more non-transitory computer-readable media of example 16 or 17, where the instructions cause the image processing unit to compute the correction table by: generating a spatial correction map from the image statistics; and combining the spatial correction map with the base correction table.

Example 19 provides the one or more non-transitory computer-readable media of example 18, where the instructions cause the image processing unit to generate the spatial correction map by: identifying, from the image statistics, an illumination region and a further illumination region, the illumination region being darker than the further illumination region; and generating the spatial correction map using the illumination region and the further illumination region.

Example 20 provides the one or more non-transitory computer-readable media of example 19, where the instructions cause the image processing unit to identify the illumination region and the further illumination region by: evaluating a plurality of candidate luminance thresholds; selecting one of the plurality of candidate luminance thresholds as an illumination boundary threshold; and classifying cells of a luminance grid as part of the illumination region or the further illumination region using the illumination boundary threshold.

Example 21 provides the one or more non-transitory computer-readable media of example 20, where the instructions cause the image processing unit to select the one of the plurality of candidate luminance thresholds as the illumination boundary threshold by: assigning thresholded values to cells of the luminance grid based on whether luminance values of the cells satisfy a given candidate luminance threshold; computing an aggregate gradient metric based on absolute differences between the thresholded values of adjacent cells of the luminance grid; and selecting the illumination boundary threshold based on the aggregate gradient metric.

Example 22 provides the one or more non-transitory computer-readable media of any one of examples 16-21, where the instructions cause the image processing unit to output the base correction table as the correction table based on the image statistics satisfying a no-activation criterion.

Example 23 provides the one or more non-transitory computer-readable media of any one of examples 18-22, where the instructions cause the image processing unit to generate the spatial correction map by: applying a three-part function to luminance values, the three-part function including a curved portion below a lower transition point, a linear transition portion between the lower transition point and an upper transition point, and a further curved portion above the upper transition point, the lower transition point and the upper transition point being defined based on an illumination boundary threshold.

Example 24 provides the one or more non-transitory computer-readable media of any one of examples 16-22, where the instructions cause the image processing unit to compute the correction table by: generating a spatial correction map from the image statistics; modifying the spatial correction map by extending or reshaping a correction region of the spatial correction map based on a detected object region intersecting the correction region; and combining the spatial correction map with the base correction table.

Example 25 provides the one or more non-transitory computer-readable media of any one of examples 16-24, where the instructions cause the image processing unit to: determine a correction strength for illumination balancing based on one or more of a brightness ratio between an illumination region and a further illumination region and a relative area weight between the illumination region and the further illumination region; and compute the correction table based on the correction strength.

Example 26 provides the one or more non-transitory computer-readable media of any one of examples 16-25, where the image statistics includes a luminance grid.

Example 27 provides the one or more non-transitory computer-readable media of any one of examples 16-26, where the instructions cause the image processing unit to compute the correction table by: generating a spatial correction map from the image statistics; resizing the spatial correction map to a size of the base correction table; and performing elementwise multiplication of values of a resized version of the spatial correction map with further values of the base correction table.

Example 28 provides the one or more non-transitory computer-readable media of any one of examples 16-27, where the pixel correction circuit is upstream of bit depth reduction logic or downsampling logic of the image processing unit.

Example 29 provides the one or more non-transitory computer-readable media of any one of examples 16-28, where the instructions cause the image processing unit to limit a correction multiplier used to compute the correction table based on a maximum enhancement limit.

Example 30 provides the one or more non-transitory computer-readable media of any one of examples 16-29, where the image statistics are derived from a frame, and the correction table is computed for a further frame subsequent to the frame.

Example 31 provides a method for image processing, including applying, by a pixel correction circuit of an image processing unit, a correction table to image data having a spatial resolution; generating, by statistics generation logic of the image processing unit, image statistics having a further spatial resolution that is lower than the spatial resolution; and computing, by illumination balancing logic of the image processing unit, the correction table based on the image statistics and a base correction table associated with the pixel correction circuit.

Example 32 provides the method of example 31, where: the pixel correction circuit includes a lens shading correction circuit; and the base correction table includes a base lens shading correction table to compensate for optical lens shading.

Example 33 provides the method of example 31 or 32, where computing the correction table includes generating a spatial correction map from the image statistics; and combining the spatial correction map with the base correction table.

Example 34 provides the method of example 33, where generating the spatial correction map includes identifying, from the image statistics, an illumination region and a further illumination region, the illumination region being darker than the further illumination region; and generating the spatial correction map using the illumination region and the further illumination region.

Example 35 provides the method of example 34, where identifying the illumination region and the further illumination region includes evaluating a plurality of candidate luminance thresholds; selecting one of the plurality of candidate luminance thresholds as an illumination boundary threshold; and classifying cells of a luminance grid as part of the illumination region or the further illumination region using the illumination boundary threshold.

Example 36 provides the method of example 35, where selecting the one of the plurality of candidate luminance thresholds as the illumination boundary threshold includes assigning thresholded values to cells of the luminance grid based on whether luminance values of the cells satisfy a given candidate luminance threshold; computing an aggregate gradient metric based on absolute differences between the thresholded values of adjacent cells of the luminance grid; and selecting the illumination boundary threshold based on the aggregate gradient metric.

Example 37 provides the method of any one of examples 31-36, further including outputting the base correction table as the correction table based on the image statistics satisfying a no-activation criterion.

Example 38 provides the method of any one of examples 33-37, where generating the spatial correction map includes applying a three-part function to luminance values, the three-part function including a curved portion below a lower transition point, a linear transition portion between the lower transition point and an upper transition point, and a further curved portion above the upper transition point, the lower transition point and the upper transition point being defined based on an illumination boundary threshold.

Example 39 provides the method of any one of examples 31-37, where computing the correction table includes generating a spatial correction map from the image statistics; modifying the spatial correction map by extending or reshaping a correction region of the spatial correction map based on a detected object region intersecting the correction region; and combining the spatial correction map with the base correction table.

Example 40 provides the method of any one of examples 31-39, further including determining a correction strength for illumination balancing based on one or more of a brightness ratio between an illumination region and a further illumination region and a relative area weight between the illumination region and the further illumination region; and computing the correction table based on the correction strength.

Example 41 provides the method of any one of examples 31-40, where the image statistics includes a luminance grid.

Example 42 provides the method of any one of examples 31-41, where computing the correction table includes generating a spatial correction map from the image statistics; resizing the spatial correction map to a size of the base correction table; and performing elementwise multiplication of values of a resized version of the spatial correction map with further values of the base correction table.

Example 43 provides the method of any one of examples 31-42, further including performing, downstream of the pixel correction circuit, bit depth reduction or downsampling.

Example 44 provides the method of any one of examples 31-43, further including limiting a correction multiplier used to compute the correction table based on a maximum enhancement limit.

Example 45 provides the method of any one of examples 31-44, where the image statistics are derived from a frame, and the correction table is computed for a further frame subsequent to the frame.

### Variations and Remarks

Although the operations of the example method shown in and described with reference to the FIGS. are illustrated as occurring once each and in a particular order, it will be recognized that the operations may be performed in any suitable order and repeated as desired. Additionally, one or more operations may be performed in parallel. Furthermore, the operations illustrated in the FIGS. may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well-known features are omitted or simplified in order not to obscure the illustrative implementations.

Further, references are made to the accompanying drawings that form a part hereof, and in which are shown, by way of illustration, examples that may be practiced. It is to be understood that other examples may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order-dependent. In particular, these operations may not be performed in the order of presentation. Operations described may be performed in a different order from the described example. Various additional operations may be performed or described operations may be omitted in additional examples.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). For the purposes of the present disclosure, the phrase “one or more of A, B, and C”, the phrase “at least one of A, B, and C”, or the phrase “at least one or more of A, B, and C” means (A), (B), (C), (A and B), (A and C), (B and C), or (A, B, and C). The term “between,” when used with reference to measurement ranges, is inclusive of the ends of the measurement ranges.

The description uses the phrases “in an example” or “in examples,” which may each refer to one or more of the same or different examples. The terms “comprising,” “including,” “having,” and the like, as used with respect to examples of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. An image processing unit, comprising:
a pixel correction circuit to apply a correction table to image data having a spatial resolution;
a statistics generation logic to generate image statistics having a further spatial resolution that is lower than the spatial resolution; and
an illumination balancing logic to compute the correction table based on the image statistics and a base correction table associated with the pixel correction circuit.

2. The image processing unit of claim 1, wherein:
the pixel correction circuit comprises a lens shading correction circuit; and
the base correction table comprises a base lens shading correction table to compensate for optical lens shading.

3. The image processing unit of claim 1, wherein the illumination balancing logic is to compute the correction table by:
generating a spatial correction map from the image statistics; and
combining the spatial correction map with the base correction table.

4. The image processing unit of claim 3, wherein the illumination balancing logic is to generate the spatial correction map by:
identifying, from the image statistics, an illumination region and a further illumination region, the illumination region being darker than the further illumination region; and
generating the spatial correction map using the illumination region and the further illumination region.

5. The image processing unit of claim 4, wherein the illumination balancing logic is to identify the illumination region and the further illumination region by:
evaluating a plurality of candidate luminance thresholds;
selecting one of the plurality of candidate luminance thresholds as an illumination boundary threshold; and
classifying cells of a luminance grid as part of the illumination region or the further illumination region using the illumination boundary threshold.

6. The image processing unit of claim 5, wherein:
the illumination balancing logic is to select the one of the plurality of candidate luminance thresholds as the illumination boundary threshold by:
assigning thresholded values to cells of the luminance grid based on whether luminance values of the cells satisfy a given candidate luminance threshold;
computing an aggregate gradient metric based on absolute differences between the thresholded values of adjacent cells of the luminance grid; and
selecting the illumination boundary threshold based on the aggregate gradient metric.

7. The image processing unit of claim 1, wherein the illumination balancing logic is to output the base correction table as the correction table based on the image statistics satisfying a no-activation criterion.

8. The image processing unit of claim 3, wherein the illumination balancing logic is to generate the spatial correction map by:
applying a three-part function to luminance values, the three-part function comprising a curved portion below a lower transition point, a linear transition portion between the lower transition point and an upper transition point, and a further curved portion above the upper transition point, the lower transition point and the upper transition point being defined based on an illumination boundary threshold.

9. The image processing unit of claim 1, wherein the illumination balancing logic is to compute the correction table by:
generating a spatial correction map from the image statistics;
modifying the spatial correction map by extending or reshaping a correction region of the spatial correction map based on a detected object region intersecting the correction region; and
combining the spatial correction map with the base correction table.

10. The image processing unit of claim 1, wherein the illumination balancing logic is to:
determine a correction strength for illumination balancing based on one or more of a brightness ratio between an illumination region and a further illumination region and a relative area weight between the illumination region and the further illumination region; and
the illumination balancing logic computes the correction table based on the correction strength.

11. The image processing unit of claim 1, wherein the image statistics comprises a luminance grid.

12. The image processing unit of claim 1, wherein the illumination balancing logic is to compute the correction table by:
generating a spatial correction map from the image statistics;
resizing the spatial correction map to a size of the base correction table; and
performing elementwise multiplication of values of a resized version of the spatial correction map with further values of the base correction table.

13. The image processing unit of claim 1, further comprising:
a bit depth reduction logic or a downsampling logic downstream of the pixel correction circuit.

14. The image processing unit of claim 1, wherein the illumination balancing logic is to limit a correction multiplier used to compute the correction table based on a maximum enhancement limit.

15. The image processing unit of claim 1, wherein the image statistics are derived from a frame, and the illumination balancing logic computes the correction table for a further frame subsequent to the frame.

16. One or more non-transitory computer-readable media storing instructions that, when executed by an image processing unit, cause the image processing unit to:
generate image statistics from image data having a spatial resolution, the image statistics having a further spatial resolution that is lower than the spatial resolution;
compute a correction table based on the image statistics and a base correction table associated with a pixel correction circuit of the image processing unit; and
output the correction table to the pixel correction circuit, wherein the pixel correction circuit is to apply the correction table to the image data.

17. The one or more non-transitory computer-readable media of claim 16, wherein:
the pixel correction circuit comprises a lens shading correction circuit; and
the base correction table comprises a base lens shading correction table to compensate for optical lens shading.

18. The one or more non-transitory computer-readable media of claim 16, wherein the instructions cause the image processing unit to compute the correction table by:
generating a spatial correction map from the image statistics; and
combining the spatial correction map with the base correction table.

19. A method for image processing, comprising:
applying, by a pixel correction circuit of an image processing unit, a correction table to image data having a spatial resolution;
generating, by statistics generation logic of the image processing unit, image statistics having a further spatial resolution that is lower than the spatial resolution; and
computing, by illumination balancing logic of the image processing unit, the correction table based on the image statistics and a base correction table associated with the pixel correction circuit.

20. The method of claim 19, wherein:
the pixel correction circuit comprises a lens shading correction circuit; and
the base correction table comprises a base lens shading correction table to compensate for optical lens shading.
